(19) United States
(12) Patent Application Publication
(10) Pub. No.: US 2023/0333816 A1
(43) Pub. Date: Oct. 19, 2023

(54) SIGNAL PROCESSING DEVICE, IMAGING DEVICE, AND SIGNAL PROCESSING METHOD

(71) Applicant: Sony Semiconductor Solutions Corporation, Kanagawa (JP)

(72) Inventor: Katsuhiko Hanzawa, Kanagawa (JP)

(21) Appl. No.: 18/042,395

(22) PCT Filed: Sep. 16, 2021
(86) PCT No.: PCT/JP2021/034103

§ 371 Date: Feb. 21, 2023

(30) Foreign Application Priority Data
Sep. 30, 2020 (JP) 2020-166280

(51) Int. Cl. G06F 7/544; G06N 3/067; H04N 23/80; H04N 25/77

(52) U.S. Cl. CPC G06F 7/5443; G06N 3/0675; H04N 23/80; H04N 25/77

(57) ABSTRACT

A signal processing device includes a multiply-accumulate operation unit arranged in a one-dimensional or two-dimensional array and capable of performing a multiply-accumulate operation in a neural network, a threshold determination processing unit that determines whether or not the input data used for operation by the multiply-accumulate operation unit is less than a predetermined threshold, and an avoidance processing unit that avoids multiply-accumulate operation processing for the input data in a case where the input data is less than the predetermined threshold.

### TECHNICAL FIELD

The present technology relates to a signal processing device, an imaging device, and a signal processing method that perform a multiply-accumulate operation.

### BACKGROUND ART

There is a case where processing related to deep neural network (DNN) such as image recognition processing for a subject is performed on an image captured by an imaging device such as a camera. In such processing related to DNN (for example, image recognition processing or the like), many multiply-accumulate operations are required.

In the multiply-accumulate operation, two types of input data such as image data and weight data are used. The two types of input data may include many zero values, and in this case, there is a problem that useless operation is performed and a memory cannot be effectively used.

In response to such a problem, for example, Patent Document 1 discloses a technique of generating an index including one or more memory address positions having input data (input activation value) that is a non-zero value. It is described that the input data can be compressed by storing only the input data that is a non-zero value in the memory, and calculation efficiency is improved.

### CITATION LIST

### Patent Document

### Patent Document 1: Japanese Translation of PCT International Application Publication No. 2020-500365

### SUMMARY OF THE INVENTION

### Problems to be Solved by the Invention

Meanwhile, in the multiply-accumulate operation executed in the image recognition processing, there are a case where data of a low bit length is input and a case where data including many non-zero values is input.

In such a case, if indexes including memory address positions are generated and stored in the memory, there is a possibility that use efficiency of the memory is rather lowered or calculation efficiency is lowered.

The present technology has been made in view of the above circumstances, and an object thereof is to improve operation efficiency of multiply-accumulate operation processing.

### Solutions to Problems

A signal processing device according to the present technology includes a multiply-accumulate operation unit arranged in a one-dimensional or two-dimensional array and capable of performing a multiply-accumulate operation in a neural network, a threshold determination processing unit that determines whether or not the input data used for operation by the multiply-accumulate operation unit is less than a predetermined threshold, and an avoidance processing unit that avoids multiply-accumulate operation processing for the input data in a case where the input data is less than the predetermined threshold.

The input data less than the predetermined threshold is, for example, input data that is a zero value, input data close to a zero value, or the like.

In the signal processing device described above, the input data may include first type input data and second type input data, the threshold determination processing unit may perform the determination for the first type input data, and the avoidance processing unit may avoid the multiply-accumulate operation processing for the first type input data in a case where the first type input data is less than the predetermined threshold.

The multiply-accumulate operation unit multiplies the first type input data by the second type input data. That is, in a case where any one of the first type input data and the second type input data is a zero value, the product also is a zero value. With this configuration, the multiply-accumulate operation processing is avoided in a case where the first type input data is a zero value.

In the signal processing device described above, the second type input data may be weight data that is information of a weight to multiply the first type input data.

The weight data is, for example, a coefficient of a filter applied to image data in a predetermined range in a convolutional neural network (CNN), and the like. It is difficult to consider a filter in which all the filter coefficients are zero values.

The threshold determination processing unit in the signal processing device described above may be provided one each for a plurality of the multiply-accumulate operation units.

It is determined whether each of a plurality of pieces of input data input to the plurality of multiply-accumulate operation units is less than a predetermined threshold, for example, whether the input data is a zero value.

The avoidance processing unit in the signal processing device described above may change the input data input to the multiply-accumulate operation unit in a case where the input data is less than the predetermined threshold in such a manner as to avoid the multiply-accumulate operation processing for the input data that is less than the predetermined threshold.

Thus, input data equal to or more than the predetermined threshold is input to the multiply-accumulate operation unit.

The signal processing device described above may include a multiply-accumulate operation control unit that manages input data and output data of the multiply-accumulate operation processing, in which the avoidance processing unit may notify the multiply-accumulate operation control unit of information for specifying the input data for which the multiply-accumulate operation processing has been avoided.

Thus, the multiply-accumulate operation control unit can grasp the correspondence between the input data used for the multiply-accumulate operation and the multiply-accumulate operation result.

The avoidance processing unit in the signal processing device described above may be provided for each of the multiply-accumulate operation units.

By providing the avoidance processing unit for each multiply-accumulate operation unit, the processing load of the determination processing executed by one avoidance processing unit is made small. In this determination processing, it is determined whether or not the input data is less than a predetermined threshold, for example, whether or not the input data is a zero value.

The avoidance processing unit in the signal processing device described above may avoid the multiply-accumulate operation processing for the input data that is less than the predetermined threshold, and output a zero value as a processing result of the multiply-accumulate operation processing.

For example, in a case where the input data is a zero value, it is obvious that an operation result is a zero value, and thus the output data is forcibly set to a zero value after avoiding the multiply-accumulate operation processing.

In the signal processing device described above, the input data may include first type input data and second type input data, and in a case where the first type input data is less than a first threshold, the avoidance processing unit may change the first type input data input to the multiply-accumulate operation unit and notify the multiply-accumulate operation control unit of information for specifying the changed first type input data.

Thus, comparison processing with a predetermined threshold for only one of the first type input data and the second type input data that are input data, for example, processing of determining whether or not the input data is a zero value can be executed.

In the avoidance processing unit in the signal processing device described above, in a case where the second type input data is less than a second threshold, the avoidance processing unit may change the second type input data input to the multiply-accumulate operation unit and change the first type input data corresponding to the changed second type input data, and notify the multiply-accumulate operation control unit of information for specifying the changed first type input data and the changed second type input data.

The corresponding data is a number to be multiplied by a number to multiply in the multiply-accumulate operation. In multiplication processing, in a case where a certain number to multiply is a zero value, the result is a zero value regardless of the value of the number to be multiplied. In order to omit such multiplication processing, processing of omitting the number to multiply that is a zero value (second type input data) and omitting the corresponding number to be multiplied is performed.

The multiply-accumulate operation control unit in the signal processing device described above may manage a multiply-accumulate operation result of the first type input data and the second type input data, and compensate a zero value for an avoided multiply-accumulate operation result.

The avoided multiply-accumulate operation processing, that is, the skipped multiply-accumulate operation processing can be specified by receiving information for specifying the corresponding first type input data and second type input data.

An imaging device according to the present technology includes a pixel array unit in which photoelectric conversion elements are arranged in a one-dimensional or two-dimensional array, a signal processing unit to which input data based on an output signal of the pixel array unit is input, in which the signal processing unit includes a multiply-accumulate operation unit arranged in a one-dimensional or two-dimensional array and capable of performing a multiply-accumulate operation in a neural network, a threshold determination processing unit that determines whether or not the input data used for operation by the multiply-accumulate operation unit is less than a predetermined threshold, and an avoidance processing unit that avoids multiply-accumulate operation processing for the input data in a case where the input data is less than the predetermined threshold.

The signal processing unit included in the imaging device is required to be power saving due to problems such as a battery.

In the imaging device described above, the pixel array unit and the signal processing unit may be integrally formed.

By integrally forming them, the imaging device can be downsized.

In the signal processing unit in the imaging device described above, feature data extracted on the basis of an output signal of the pixel array unit may be input to the signal processing unit as the input data.

The feature data often includes data having a zero value or less than a predetermined threshold.

A signal processing method according to the present technology is a signal processing method for executing, by a signal processing device, processing including determining whether or not input data used for multiply-accumulate operation in a neural network is less than a predetermined threshold, and avoiding multiply-accumulate operation processing for the input data in a case where the input data is less than the predetermined threshold.

Even with such a signal processing method, a similar operation and effect to those of the signal processing device according to the present technology described above can be obtained.

### BRIEF DESCRIPTION OF DRAWINGS

FIG. 1 is a diagram illustrating a configuration example of an imaging device as an embodiment according to the present technology.

FIG. 2 is a diagram illustrating an internal configuration example of a sensor unit.

FIG. 3 is a diagram illustrating a configuration example of a signal processing unit.

FIG. 4 is a diagram illustrating an example of processing target data (pixel data) and a target area.

FIG. 5 is a diagram illustrating an example of a filter applied to the target area.

FIG. 6 is a diagram for describing that a multiply-accumulate operation is performed in MACs.

FIG. 7 is a diagram illustrating configuration example 1 of the signal processing unit.

FIG. 8 is a diagram for describing a process in which pixel data as input data is replaced in configuration example 1 of the signal processing unit together with FIG. 9, and this diagram illustrates a state before replacement.

FIG. 9 is a diagram illustrating a state after replacement of the pixel data as the input data.

FIG. 10 is a diagram illustrating configuration example 2 of the signal processing unit.

FIG. 11 is a diagram illustrating an example of a filter in configuration example 2 of the signal processing unit.

FIG. 12 is a diagram illustrating an example of a target area in configuration example 2 of the signal processing unit.

FIG. 13 is a diagram for describing a process in which weight data as input data is replaced in configuration example 2 of the signal processing unit together with FIGS. 14 and 15, and this diagram illustrates a state before the replacement.

FIG. 14 is a diagram illustrating weight data to be replaced.

FIG. 15 is a diagram illustrating a state after replacement of the weight data as the input data.

FIG. 16 is a diagram illustrating an example of the filter and the target area in configuration example 3 of the signal processing unit.

FIG. 17 is a diagram illustrating configuration example 3 of the signal processing unit.

FIG. 18 is a diagram for describing a process in which pixel data as input data is replaced in configuration example 3 of the signal processing unit together with FIG. 19, and this diagram illustrates a state before replacement.

FIG. 19 is a diagram illustrating a state after replacement of the pixel data as the input data.

FIG. 20 is a diagram illustrating configuration example 4 of the signal processing unit.

FIG. 21 is a diagram illustrating a configuration example of a MAC in configuration example 4 of the signal processing unit.

FIG. 22 is a flowchart illustrating a first processing example.

FIG. 23 is a flowchart illustrating a second processing example.

FIG. 24 is a flowchart illustrating the second processing example.

FIG. 25 is a flowchart illustrating a third processing example.

FIG. 26 is a diagram illustrating a configuration example of a MAC in a second modification.

FIG. 27 is a diagram illustrating an example in which the signal processing unit is provided in a control unit outside the sensor unit.

FIG. 28 is a diagram illustrating an example in which the signal processing unit is provided outside the sensor unit and outside the control unit.

FIG. 29 is a diagram illustrating an example in which the signal processing unit is provided outside the imaging device.

### MODE FOR CARRYING OUT THE INVENTION

Hereinafter, embodiments according to the present technology will be described in the following order with reference to the accompanying drawings.
<1. Configuration of imaging device>
<2. Specific configuration example of signal processing unit>
<2-1. Configuration example 1>
<2-2. Configuration example 2>
<2-3. Configuration example 3>
<2-4. Configuration example 4>
<3. Flowchart>
<3-1. First processing example>
<3-2. Second processing example>
<3-3. Third processing example>
<4. Modifications>
<4-1. First modification>
<4-2. Second modification>
<4-3. Modification of sensor unit>
<4-4. Other modifications>
<5. Summary>
<6. Present technology>

### 1. CONFIGURATION OF IMAGING DEVICE

A signal processing device of the present technology is capable of executing various operations regarding image recognition processing by a deep neural network (DNN). In the following examples, a signal processing device that performs multiply-accumulate operation processing as image recognition processing by a convolutional neural network (CNN) that is a type of DNN will be described.

Furthermore, various use modes of the signal processing device are conceivable. In the following example, an example in which the signal processing device is provided and used in an imaging device will be described.

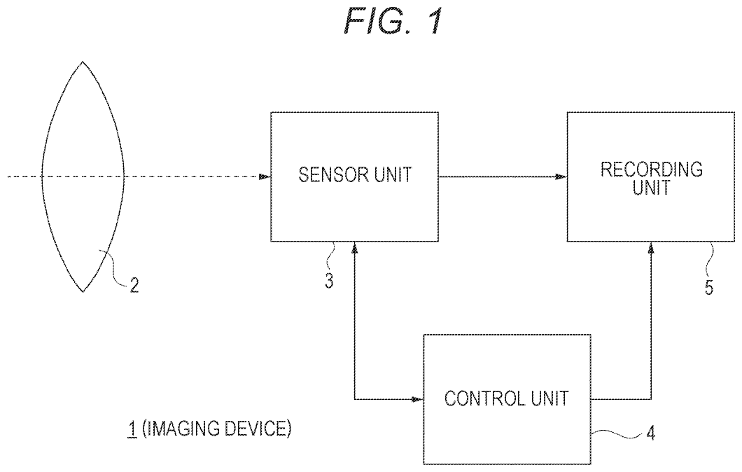

As illustrated in FIG. 1, the imaging device 1 includes an imaging lens 2, a sensor unit 3, a control unit 4, and a recording unit 5.

Various modes of the imaging device 1, for example, a camera mounted on an industrial robot, an in-vehicle camera, a monitoring camera, and the like are assumed.

The imaging lens 2 condenses incident light and guides the light to the sensor unit 3. The imaging lens 2 can include a plurality of lenses.

The sensor unit 3 includes a plurality of light receiving elements, and outputs a signal obtained by photoelectric conversion.

The control unit 4 performs control of a shutter speed of the sensor unit 3, an instruction of various types of signal processing in each unit included in the imaging device 1, an imaging operation and a recording operation according to an operation of a user, a reproduction operation of a recorded image file, drive control (for example, zoom control, focus control, diaphragm control, and the like) of the imaging lens 2, user interface control, and the like.

The recording unit 5 stores information and the like used by the control unit 4 for processing. As the recording unit 5, for example, a read only memory (ROM), a random access memory (RAM), a flash memory, and the like are comprehensively illustrated.

The recording unit 5 may be a memory area built in a microcomputer chip as the control unit 4, or may include a separate memory chip.

The control unit 4 controls the entire imaging device 1 by executing a program stored in a ROM, a flash memory, or the like of the recording unit 5.

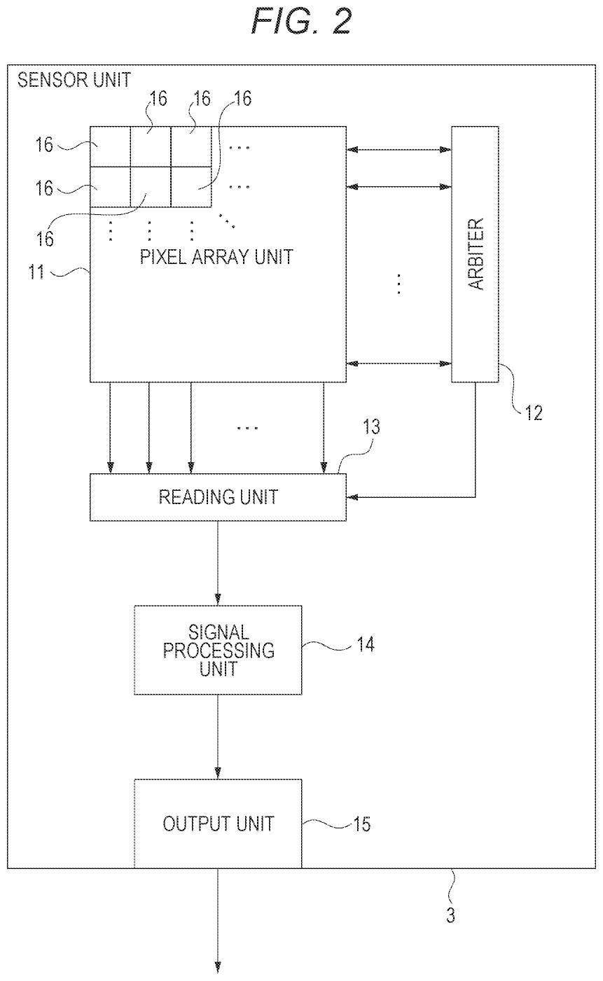

The sensor unit 3 will be specifically described with reference to FIG. 2. The sensor unit 3 includes a pixel array unit 11 functioning as what is called a dynamic vision sensor (DVS), an arbiter 12, a reading unit 13, a signal processing unit 14, and an output unit 15.

Note that the sensor unit 3 is not limited to the DVS, and may be configured as various image sensors.

In the pixel array unit 11, pixels 16 each including a photoelectric conversion element are arranged in a two-dimensional array in a row direction (horizontal direction) and a column direction (vertical direction).

Each pixel 16 detects the presence or absence of an event by whether or not the amount of change in the amount of received light exceeds a predetermined threshold, and outputs a request to the arbiter 12 when an event occurs.

The arbiter 12 arbitrates the request from each pixel 16 and controls a read operation by the reading unit 13.

The reading unit 13 performs the read operation on each pixel 16 of the pixel array unit 11 on the basis of the control of the arbiter 12.

Each pixel 16 outputs a signal based on a difference between the reference level and the current level of a light receiving signal according to the read operation by the reading unit 13.

The signal read from each pixel 16 is stored in the memory as a differential signal.

Furthermore, the pixel 16 resets the reference level to the level of the current light receiving signal according to the output of the difference signal. Thus, the amount of change in the light reception amount with respect to the reference level can be detected again.

The reading of the difference signal and the resetting of the reference level are not performed until the amount of change in the light reception amount exceeds the predetermined threshold.

The signal processing unit 14 executes various types of signal processing (preprocessing and the like), image recognition processing by DNN, and the like on image data input from the reading unit 13 as feature amount data. In the following description, the image recognition processing by CNN that is a type of DNN will be described as an example.

Specifically, as the image recognition processing, for example, operation processing related to convolution processing by a convolution layer, max pooling processing by a pooling layer, classification processing by a fully connected layer and an output layer, and the like can be executed. In the following description, an example in which multiply-accumulate operation processing in the convolution processing or the like is executed in the signal processing unit 14 as the image recognition processing will be described.

The output unit 15 outputs a classification result by the CNN to the control unit 4 in the subsequent stage on the basis of a predetermined interface standard (for example, a mobile industry processor interface (MIPI) or the like).

The control unit 4 receives the classification result by the CNN and uses the classification result for various types of processing.

Note that, in a case where the signal processing unit 14 executes only a part of the various processes related to the CNN, a processing result in the signal processing unit 14, that is, an intermediate processing result in the CNN is output from the output unit 15.

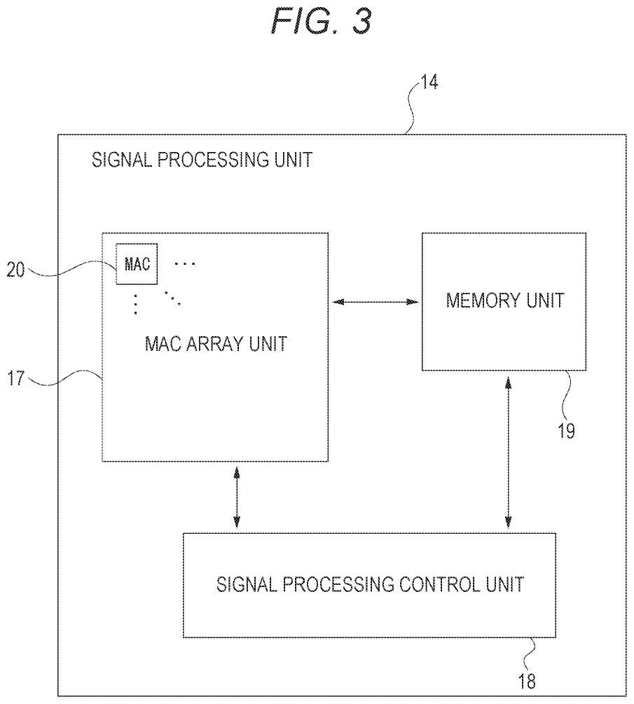

A configuration example of the signal processing unit 14 will be described with reference to FIG. 3.

The signal processing unit 14 includes a MAC array unit 17, a signal processing control unit 18, and a memory unit 19 in order to execute the multiply-accumulate operation processing.

The MAC array unit 17 includes multiply-accumulate (MAC) units arranged in a two-dimensional array in a row direction (horizontal direction) and a column direction (vertical direction). Note that the multiply-accumulate operation units may be arranged in a one-dimensional array along one of the row direction and the column direction.

The multiply-accumulate operation unit is also referred to as the MAC 20.

In each of the MACs 20, a circuit for performing multiplication processing and addition processing on data input from the memory unit 19 is formed.

The input data input to one MAC 20 is, for example, data for one pixel of image data output from the pixel array unit 11 or weight data to multiply the data for one pixel. The weight data is a filter coefficient of a filter applied to the image data.

Note that image data input to the MAC 20 may be not only the image data output from the pixel array unit 11 but also output image data in another convolution layer or pooling layer. In the following description, such image data is referred to as “processing target data”.

An example of the operation performed by the MAC 20 will be described using processing target data represented by binary values (0 and 1) and a filter having two pixels both vertically and horizontally to be applied to the processing target data.

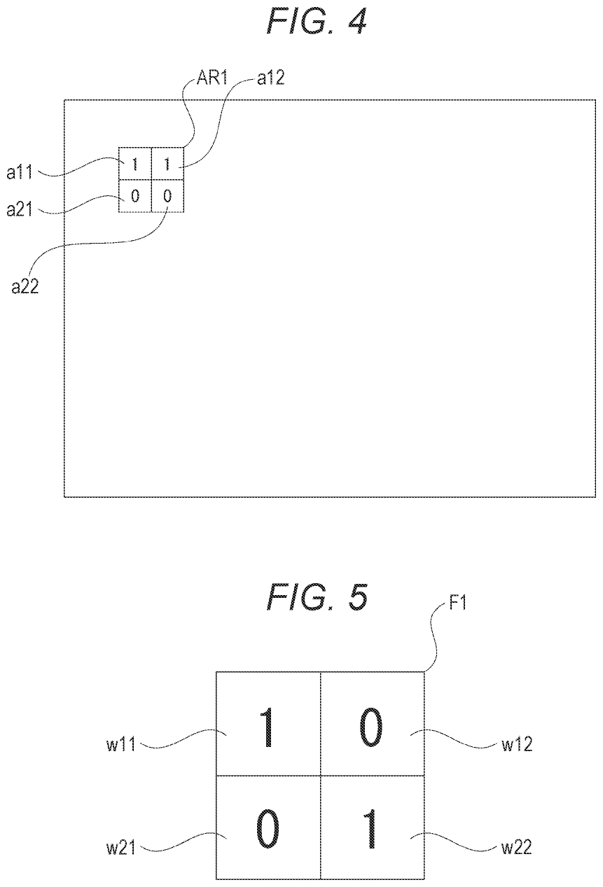

FIG. 4 is a diagram illustrating processing target data and a target area AR1 that is a target area of the filter is applied. Among the four pixels in the target area AR1, a value of an upper left pixel data a11 and a value of an upper right pixel data a12 are both “1”, and a value of a lower left pixel data a21 and a value of a lower right pixel data a22 are both “0”.

FIG. 5 is a diagram illustrating a filter F1 applied to the target area AR1. Coefficients of the filter F1 are weight data w11, w12, w21, and w22.

In the filter F1, values of the upper left weight data w11 and the lower right weight data w22 are “1”, and values of the upper right weight data w12 and the lower left weight data w21 are “0”.

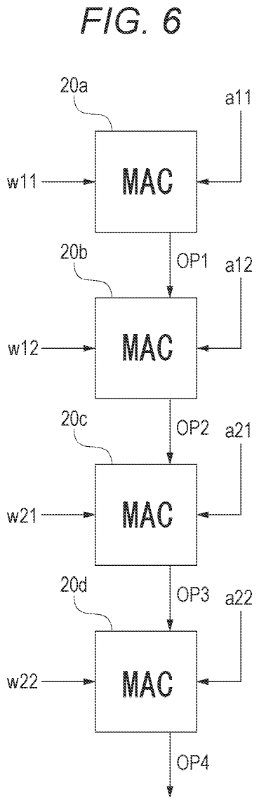

In the convolution processing (see FIG. 6) in this case, the operation of the following expression (1) is executed.

a11×w11+a12×w12+a21×w21+a22×w22 Expression (1)

The operation of Expression (1) can be performed using the four MACs 20.

For example, pixel data a11 and weight data w11 are input to a MAC 20a. Then, in the MAC 20a, multiplication processing of the pixel data a11 and the weight data w1l is performed, and a multiplication result is output as an output OP1.

Not only the pixel data a12 and the coefficient w12 but also the output OP1 is input to a MAC 20b. The MAC 20b performs multiplication processing of the pixel data a12 and the coefficient w12, and further performs addition processing of a result of the multiplication processing and the output OP1. The addition result is output as an output OP2.

Pixel data a21, weight data w21, and the output OP2 are input to a MAC 20c. The MAC 20c performs multiplication processing of the pixel data a21 and the weight data w21, and performs addition processing of a result of the multiplication processing and the output OP2. The addition result is output as an output OP3.

Pixel data a22, weight data w22, and the output OP3 are input to a MAC 20d. The MAC 20d performs multiplication processing of the pixel data a22 and the weight data w22, and performs addition processing of a result of the multiplication processing and the output OP3. The addition result is output as an output OP4.

Thus, an operation result of Expression (1) is output from the MAC 20d as the output OP4.

Note that the example illustrated in FIG. 6 is an example, and for example, the MACs 20a, 20b, 20c, and 20d may be controlled to perform only multiplication processing. In that case, the processing of adding the outputs OP1, OP2, OP3, and OP4 may be executed in MACs 20 other than the MACs 20a, 20b, 20c, and 20d. Of course, the MAC 20d may be configured to perform processing of adding the outputs OP1, OP2, and OP3 to the multiplication result so that the output OP4 becomes the operation result of Expression (1).

The description returns to FIG. 3.

The signal processing control unit 18 performs processing of reading processing target data (pixel data) and filter coefficients (weight data) stored in the memory unit 19 and inputting the data to each MAC 20 of the MAC array unit 17. Furthermore, the signal processing control unit 18 has a function of avoiding an operation in which the operation result becomes a zero value. This will be specifically described later.

The signal processing control unit 18 performs processing of storing the operation result of the MAC array unit 17 in the memory unit 19. Furthermore, processing of transmitting the operation result to the outside of the signal processing control unit 18 is performed.

The imaging device 1 illustrated in FIGS. 1, 2, and 3 is an example including an image sensor in which a pixel array unit 11 and a signal processing unit 14 are integrally formed. For example, this is an example in which the pixel array unit 11 and the like are arranged on the front surface, and a GPU, a DSP, and the like as the signal processing unit 14 are formed on the back surface.

However, the image sensor may not include the signal processing unit 14. That is, the image sensor and the signal processing unit 14 may be provided separately.

### 2. SPECIFIC CONFIGURATION EXAMPLE OF SIGNAL PROCESSING UNIT

A specific configuration example of the signal processing unit 14 will be described with reference to the accompanying drawings.

### 2-1. Configuration Example 1

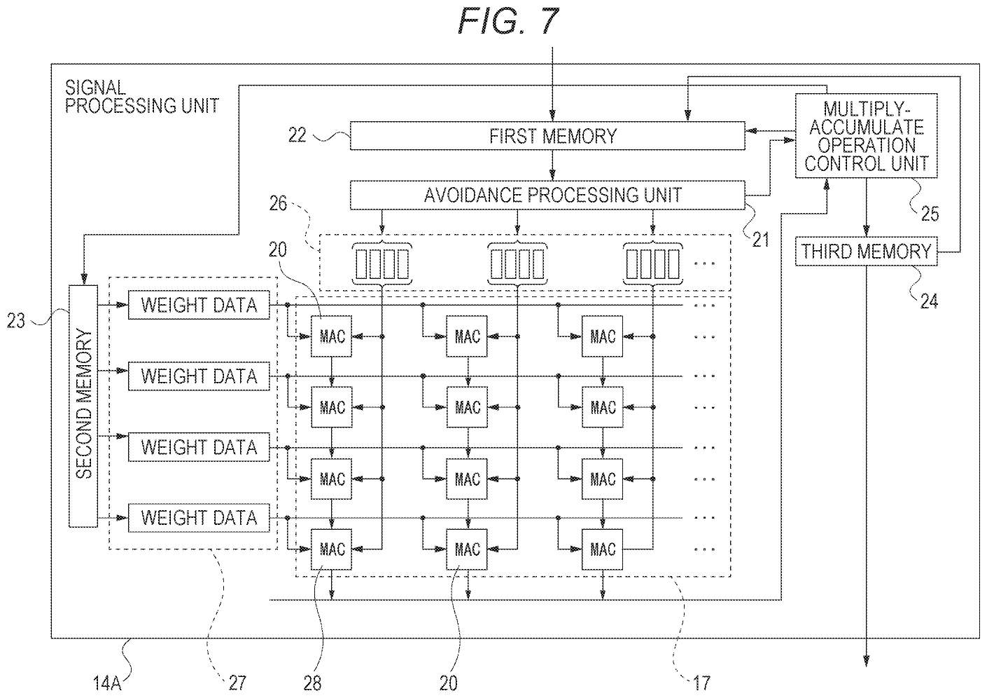

A specific configuration of the signal processing unit 14A in configuration example 1 is illustrated in FIG. 7.

In the signal processing unit 14A in configuration example 1, an avoidance processing unit 21 is provided in any one of two pieces of data input to the multiplication circuit of the MAC 20, specifically, the above-described pixel data and weight data (filter coefficient). Furthermore, one avoidance processing unit 21 is provided for each of the plurality of MACs 20. In the example illustrated in FIG. 7, one avoidance processing unit 21 is provided for one MAC array unit 17 including a plurality of MACs 20.

As illustrated in FIG. 7, the signal processing unit 14A includes the avoidance processing unit 21, a first memory 22, a second memory 23, a third memory 24, a multiply-accumulate operation control unit 25, a first local memory 26, a second local memory 27, and a plurality of MACs 20 arranged in a two-dimensional array and constituting the MAC array unit 17.

The avoidance processing unit 21 and the multiply-accumulate operation control unit 25 are signal processing control units 18 illustrated in FIG. 3.

Furthermore, the first memory 22, the second memory 23, and the third memory 24 are the memory unit 19 illustrated in FIG. 3. The first memory 22, the second memory 23, and the third memory 24 may be provided as physically different memories, or may be provided as different areas of one memory.

The first memory 22 stores image data as the processing target data. The second memory 23 stores weight data. The third memory 24 stores an operation result. The operation result stored in the third memory 24 may be output from the signal processing unit 14, or may be output to the first memory 22 as the processing target data input to the MAC array unit 17. Note that the operation result stored in the third memory 24 may be input from the third memory 24 to the MAC array unit 17 without passing through the first memory 22.

The avoidance processing unit 21 reads the processing target data from the first memory 22 and inputs the processing target data to each MAC 20 of the MAC array unit 17 via the first local memory 26.

The weight data stored in the second memory 23 is temporarily stored in the second local memory 27, and then input to each MAC 20 of the MAC array unit 17.

In each MAC 20, multiplication of pixel data for one pixel and weight data in the input processing target data is performed.

Here, the multiply-accumulate operation in the MAC 20 may be wasted depending on the input processing target data. For example, in the examples illustrated in FIGS. 4, 5, and 6, in a case where all of the pixel data a11, a12, a21, and a22 are zero values, the operation result of Expression (1) always becomes a zero value regardless of the values of the weight data w11, w12, w21, and w22, and thus it is not necessary to perform the multiply-accumulate operation.

The avoidance processing unit 21 performs processing for avoiding such unnecessary operation.

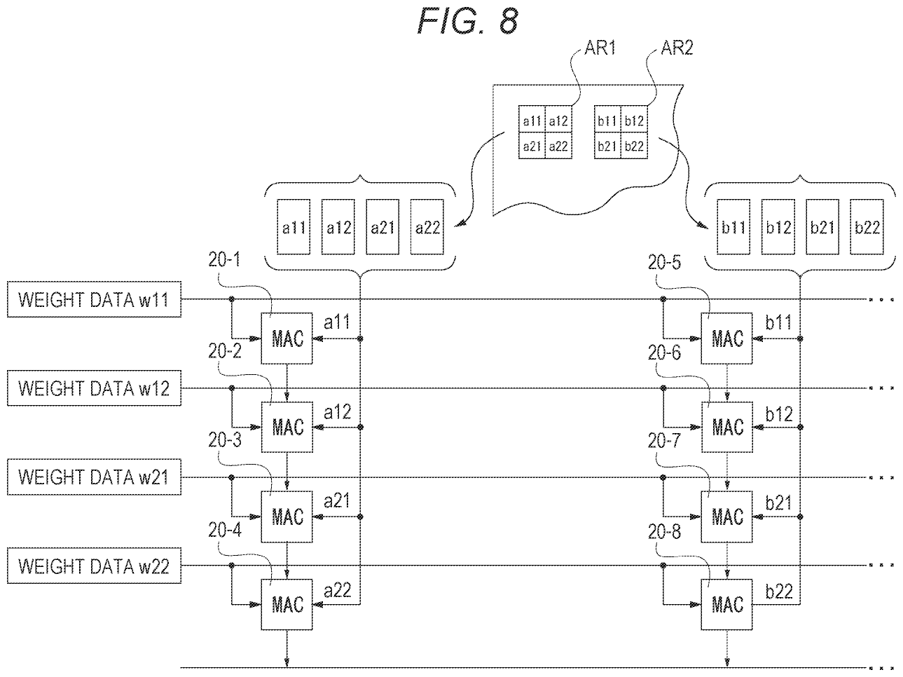

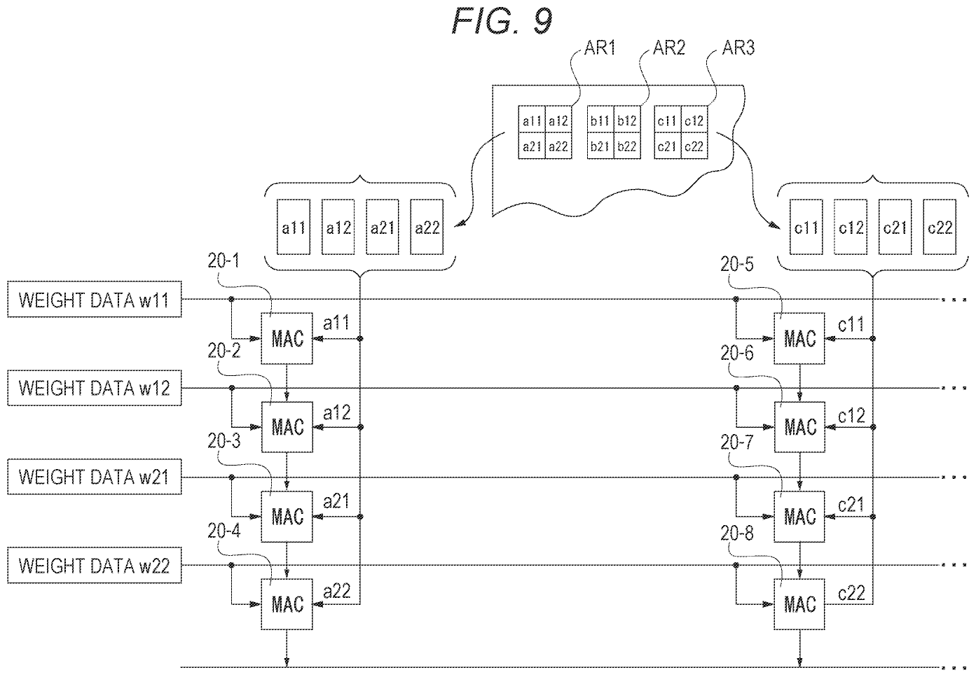

This will be specifically described with reference to FIGS. 8 and 9.

FIG. 8 is an excerpt from the MAC array unit 17 illustrated in FIG. 7. Specifically, among the plurality of MACs 20, eight MACs 20-1, MAC 20-2, MAC 20-3, MAC 20-4, MAC 20-5, MAC 20-6, MAC 20-7, and MAC 20-8 are illustrated.

The four MACs 20 of MACs 20-1, 20-2, 20-3, and 20-4 are multiply-accumulate operation units that perform the convolution processing for the target area AR1 to which the filter is applied in the processing target data.

The four MACs 20 of MACs 20-5, 20-6, 20-7, and 20-8 are multiply-accumulate operation units that perform the convolution processing for a target area AR2 to which the filter is applied in the processing target data.

Here, it is assumed that all the pixel data of the target area AR2 are zero values. That is, the pixel data b11, b12, b21, and b22 are all zero values.

In this case, the four MACs 20 of the MAC 20-5, the MAC 20-6, the MAC 20-7, and the MAC 20-8 do not need to perform the multiply-accumulate operation processing.

Therefore, the avoidance processing unit 21 avoids the convolution processing (multiply-accumulate operation processing) for the target area AR2 and performs the convolution processing for a target area AR3 instead.

That is, the pixel data c11, c12, c21, and c22 of the target area AR3 are input to the four MACs 20 of the MAC 20-5, the MAC 20-6, the MAC 20-7, and the MAC 20-8 (see FIG. 9).

In this manner, in a case where all the pieces of pixel data in the target area AR are zero values, the multiply-accumulate operation processing for the target area AR is stopped, and the MAC 20 is used for the multiply-accumulate operation processing for another target area AR.

Note that, in FIGS. 8 and 9, the target areas AR1, AR2, and AR3 are illustrated not to overlap each other in order to simplify the description, but there is a case where the target areas AR1, AR2, and AR3 partially overlap each other depending on the stride amount (shift amount) of the filter. For example, in a case where the stride amount is “1”, the pixel data a12 of the target area AR1 and the pixel data bl1 of the target area AR2 are the same pixel data.

The description returns to FIG. 7.

The multiply-accumulate operation control unit 25 performs processing of storing the operation result output from the MAC array unit 17 in the third memory 24. At this time, unless the relationship between the operation result output from the MAC array unit 17 and the target area AR is correctly associated, the result of the convolution processing cannot be appropriately handled.

Therefore, when the processing of avoiding the unnecessary operation is performed as described above, the avoidance processing unit 21 notifies the multiply-accumulate operation control unit 25 of information for specifying the avoided operation or information for specifying which target area AR the operation performed using the MAC array unit 17 belongs to.

Upon receiving the notification, the multiply-accumulate operation control unit 25 stores the multiply-accumulate operation result in the third memory 24. At this time, a zero value is stored in the third memory 24 for the multiply-accumulate operation result that have been avoided.

Thus, the multiply-accumulate operation control unit 25 can appropriately handle the operation result output from the MAC array unit 17.

Note that, as a method of skipping the operation in a case where the input data is set to a zero value and the operation result is set to a zero value, there is a method of storing only a non-zero value assigned with an address in a memory and not storing a zero value in the memory (for example, see Patent Document 1). In this case, when the quantization bit length of the input data is large, it is possible to improve memory use efficiency and reduce power consumption by assigning an address and selectively storing the input data in the memory.

However, it has been considered to reduce the quantization bit length of input data in order to improve the operation speed (image recognition processing speed) and power consumption. When the quantization bit length is decreased, the quantization bit length of the input data is finally set to 1 bit.

In this case, in the method of storing only the non-zero value in the memory in association with the address, if the input data of the non-zero value is not considerably large, the effect of improving the use efficiency of the memory becomes small or cannot be obtained.

Specifically, in a case where the quantization bit length is N (bit), the bit rate of the address is Log (2, number of pieces of data), and the non-zero value rate is R, the necessary memory amount is expressed by the following Expression (2). Here, “2” in Log (2, number of pieces of data) represents a base, and “number of pieces of data” represents a true number.

Number of pieces of data×N×Log(2, number of pieces of data)×R Expression (2)

As understood from Expression (2), in the method of storing only the non-zero value in the memory in association with the address, in the case of N=1, the memory use efficiency cannot be improved unless the value of R is small.

According to this configuration, since the address is not added, even in a case where the quantization bit length of the input data is reduced, it is possible to reliably obtain the effect of improving the use efficiency of the memory and the effect of reducing the power consumption by the amount obtained by skipping the multiply-accumulate operation.

### 2-2. Configuration Example 2

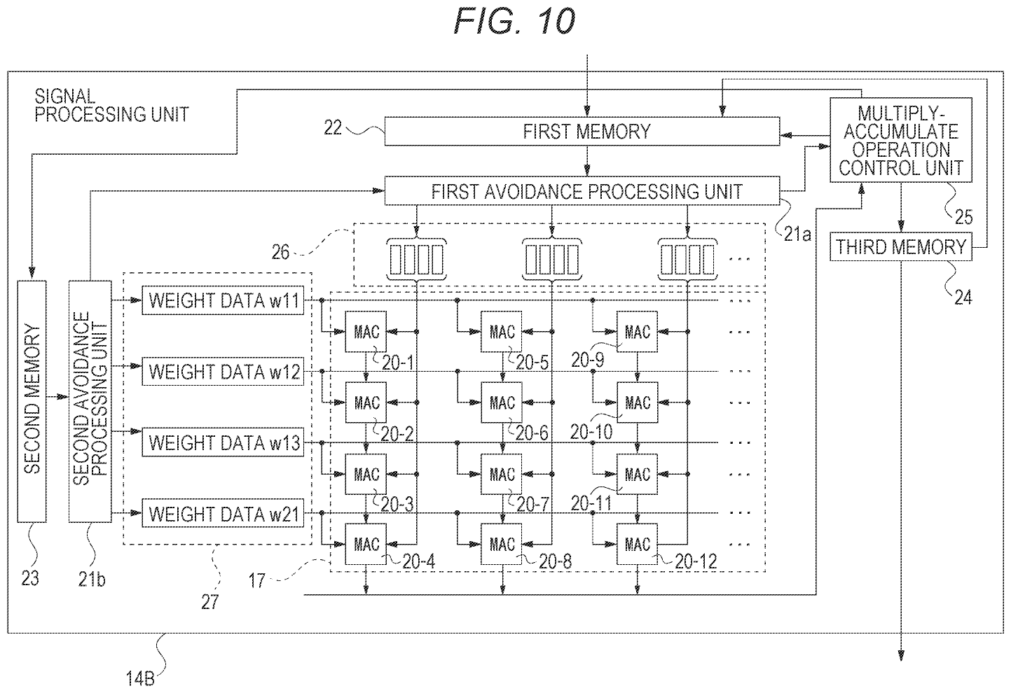

FIG. 10 illustrates a specific configuration of the signal processing unit 14B in configuration example 2.

The signal processing unit 14B in configuration example 2 has a configuration to avoid the multiply-accumulate operation related to weight data w in a case where a part of the weight data w in the filter F is a zero value. That is, the signal processing unit 14B includes a second avoidance processing unit 21b.

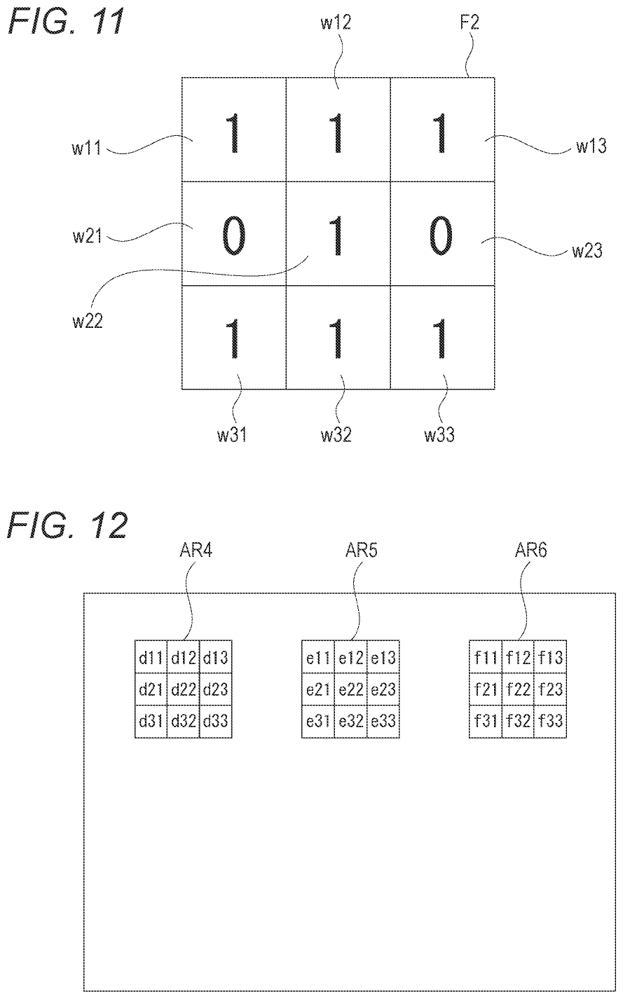

FIG. 11 illustrates the filter F2 in this example, and FIG. 12 illustrates the processing target data and target areas AR4, AR5, and AR6.

The filter F2 has three pixels both vertically and horizontally. Accordingly, the target areas AR4, AR5, and AR6 are also areas of three pixels in the vertical and horizontal directions.

The values of the weight data w11, w12, w13, w22, w31, w32, and w33 in the filter F2 are “1”, and the values of the weight data w21 and w23 are “0”.

The target area AR4 is set as pixel data d11, d12, d13, d21, d22, d23, d31, d32, and d33. The target area AR5 is set as pixel data e11, e12, e13, e21, e22, e23, e31, e32, and e33. The target area AR6 includes pixel data f11, f12, fl3, f21, f22, f23, f31, f32, and f33.

The processing target data stored in the first memory 22 is input to each MAC 20 of the MAC array unit 17 via the first avoidance processing unit 21a (see FIG. 10).

The weight data stored in the second memory 23 is input to each MAC 20 of the MAC array unit 17 via the second avoidance processing unit 21b.

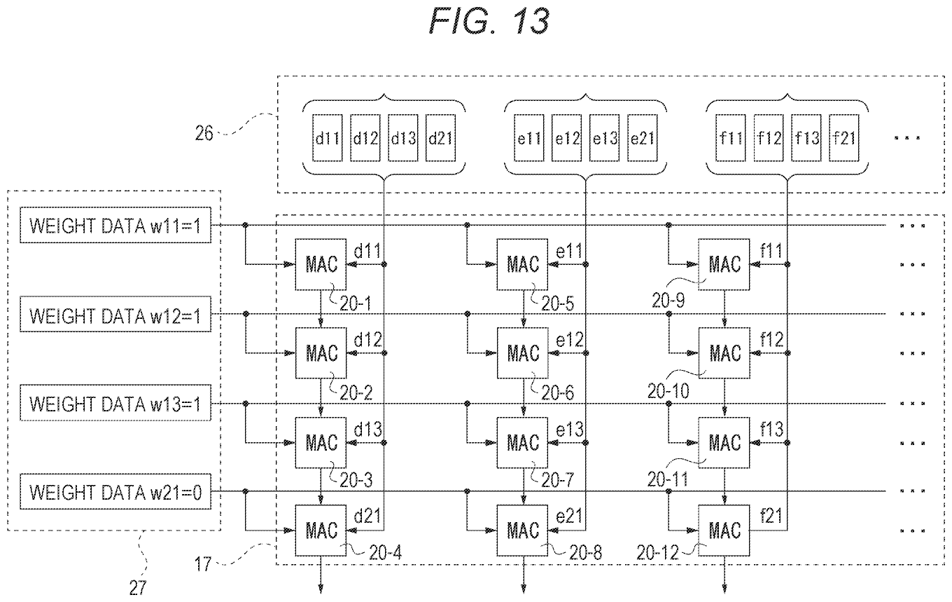

The weight data w11 (=1) is input to the MAC 20-1, the weight data w12 (=1) is input to the MAC 20-2, the weight data w13 (=1) is input to the MAC 20-3, and the weight data w21 (=0) is input to the MAC 20-4 (see FIG. 13).

Here, the multiplication processing related to the weight data w21 becomes a zero value regardless of the pixel data, and thus can be avoided.

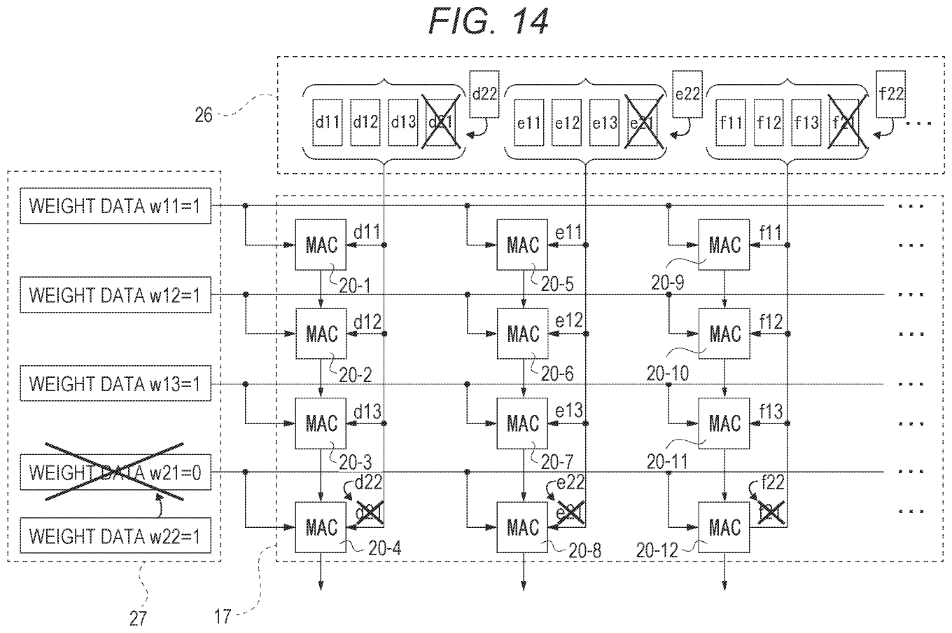

Therefore, the second avoidance processing unit 21b stops the multiply-accumulate operation using the weight data w21 and performs the multiply-accumulate operation using the weight data w22 instead (see FIG. 14).

Furthermore, along with this, the second avoidance processing unit 21b notifies the first avoidance processing unit 21a of the weight data w21 that has been avoided and the weight data w22 that has been newly employed (see FIG. 10).

The first avoidance processing unit 21a stops inputting the pixel data d21, e21, and f21 scheduled to be used in the multiplication processing related to the weight data w22 to the MAC 20-4, the MAC 20-8, and the MAC 20-12, and determines to input the pixel data d22, e22, and f22 used in the multiplication processing related to the weight data w22 employed instead to the MAC 20-4, the MAC 20-8, and the MAC 20-12 (see FIG. 14).

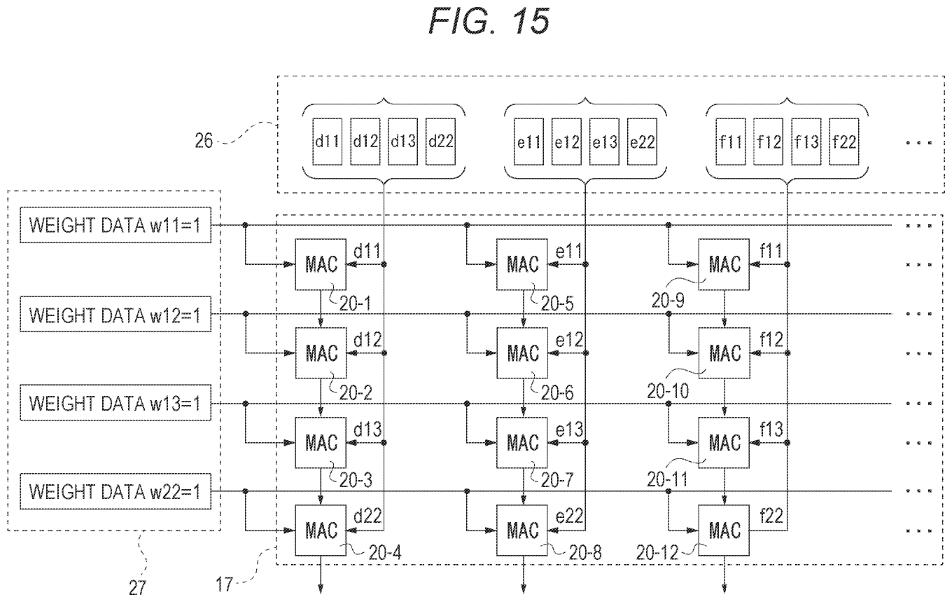

That is, the pixel data and the weight data w input to the MAC array unit 17 are as illustrated in FIG. 15.

Note that the first avoidance processing unit 21a notifies the multiply-accumulate operation control unit 25 of the pixel data d21, e21, and f21 for which the multiply-accumulate operation is avoided and the pixel data d22, e22, and f22 used for the multiply-accumulate operation instead, so that the multiply-accumulate operation control unit 25 can appropriately handle the operation result. In addition, instead of performing notification of the pixel data, the first avoidance processing unit 21a may notify the multiply-accumulate operation control unit 25 of the weight data w for which the multiply-accumulate operation is avoided and the weight data w employed instead.

The multiply-accumulate operation control unit 25 stores the multiply-accumulate operation result output from the MAC array unit 17 in the third memory 24. At this time, a zero value is stored in the third memory 24 for the multiply-accumulate operation result that have been avoided.

Thus, the multiply-accumulate operation control unit 25 can appropriately handle the operation result output from the MAC array unit 17.

Note that, in FIGS. 13, 14, and 15, the weight data set to the zero value and the pixel data corresponding thereto are illustrated as being temporarily loaded to the first local memory 26 and the second local memory 27. However, in practice, determination processing as to whether or not the pixel data is a zero value or determination processing as to whether or not the pixel data is pixel data corresponding thereto may be performed before the pixel data is loaded into the first local memory 26 or the second local memory 27. In this case, the weight data having the zero value and the corresponding pixel data are not loaded into the first local memory 26 or the second local memory 27.

### 2-3. Configuration Example 3

The signal processing unit 14C in configuration example 3 has a configuration for applying a plurality of filters F3, F4, and F5 to one target area AR.

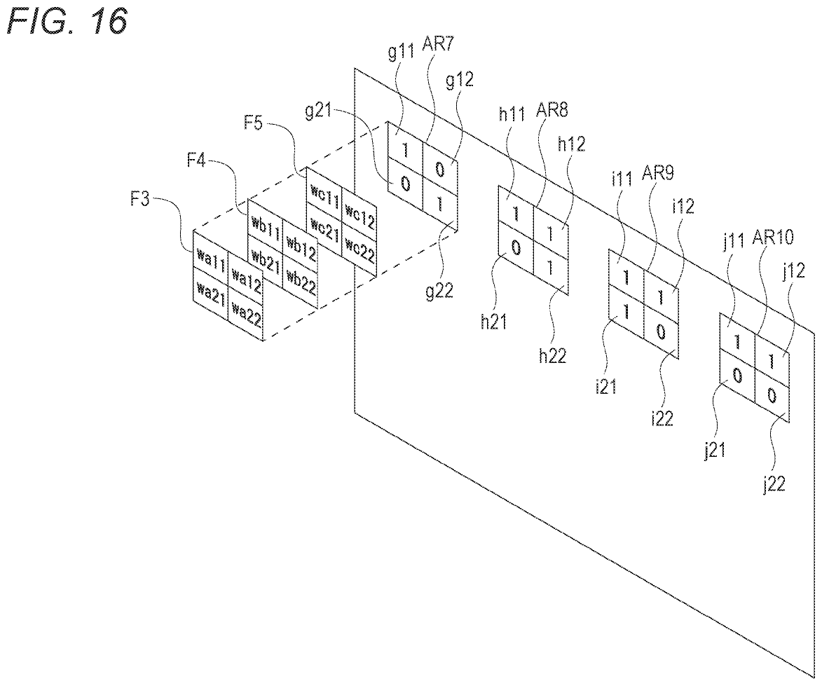

Specifically, four target areas AR7, AR8, AR9, and AR10 and three filters F3, F4, and F5 will be described as an example with reference to FIG. 16.

The target areas AR7, AR8, AR9, and AR10 are areas of two pixels both vertically and horizontally. The target area AR7 includes pixel data g11, g12, g21, and g22. Similarly, the target area AR8 includes pixel data h11, h12, h21, and h22, the target area AR9 includes pixel data i11, i12, i21, and i22, and the target area AR10 includes pixel data j11, j12, j21, and j22.

The filters F3, F4, and F5 applied to the target areas AR7, AR8, AR9, and AR10 each also have a size of two pixels both vertically and horizontally.

The filter F3 includes weight data wa11, wa12, wa21, and wa22, the filter F4 includes weight data wb11, wb12, wb21, and wb22, and the filter F5 includes weight data wc11, wc12, wc21, and wc22.

For example, by applying the filter F3 to the target area AR7, operation of g11×wa11+g12×wa12+g21×wa21+g22×wa22 is performed. Moreover, by applying the filter F4 to the target area AR7, operation of g11×wb11+g12×wb12+g21×wb21+g22×wb22 is performed. Then, by applying the filter F5 to the target area AR7, operation of g11×wc11+g12×wc12+g21×wc21+g22×wc22 is performed.

Then, in a convolution operation, one operation result is obtained by adding the operation result obtained by applying the filter F3 to the target area AR7, the operation result obtained by applying the filter F4 thereto, and the operation result obtained by applying the filter F5 thereto.

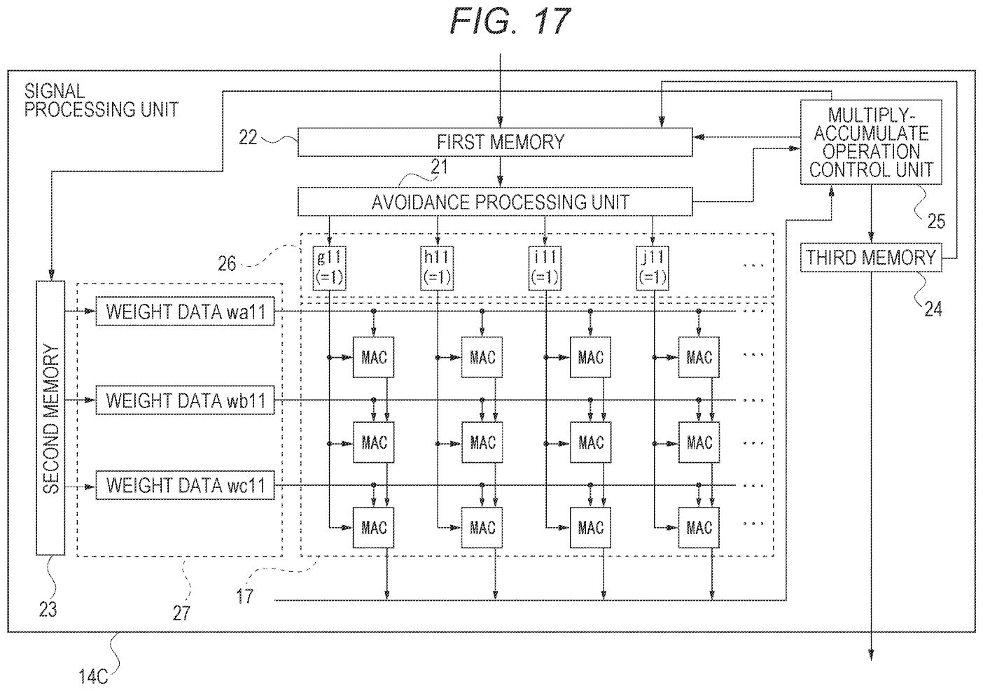

FIG. 17 illustrates a configuration example of the signal processing unit 14C in a case where such convolution processing is performed.

The signal processing unit 14C includes the first memory 22 and the avoidance processing unit 21, and the avoidance processing unit 21 performs processing of loading pixel data stored in the first memory 22 to the first local memory 26.

Thus, the pixel data g11 of the target area AR7, the pixel data h11 of the target area AR8, the pixel data i11 of the target area AR9, and the pixel data j11 of the target area AR10 are loaded into the first local memory 26.

The signal processing unit 14C includes the second memory 23 and the second local memory 27, and loads the weight data stored in the second memory 23 to the second local memory 27.

Thus, the weight data wall of the filter F3, the weight data wb11 of the filter F4, and the weight data wc11 of the filter F5 are loaded into the second local memory 27.

Meanwhile, in the convolution processing for the target area AR7, it is necessary to perform the multiplication processing four times for each filter F, that is, 12 times in total. As illustrated in FIG. 17, in a case where the operation processing is performed once using the MAC array unit 17, the multiplication processing is executed three times out of 12 times.

Therefore, in order to end the convolution processing for the target area AR7, four times of the operation processing using the MAC array unit 17 are necessary.

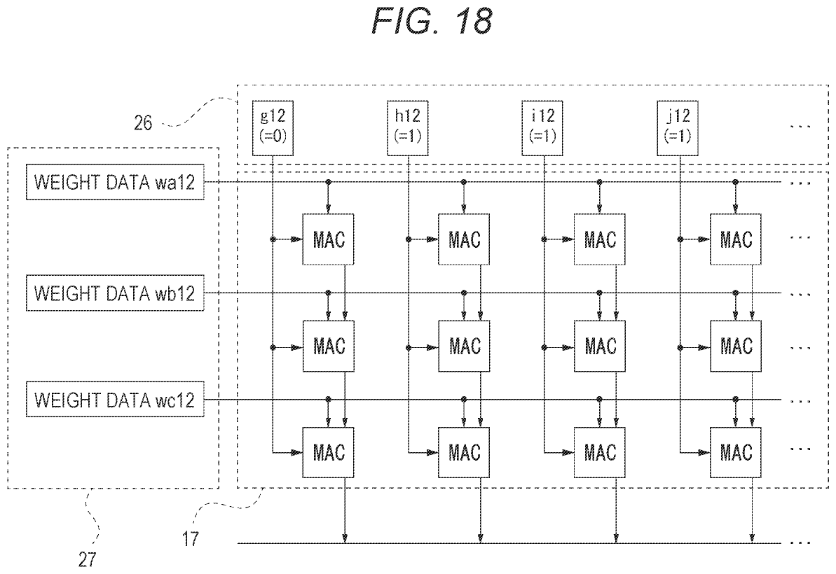

For example, FIG. 18 illustrates the second operation processing for the target area AR7 using the MAC array unit 17.

As illustrated in FIGS. 17 and 18, the convolution processing in this example can be achieved by repeating the multiply-accumulate operation using the MAC array unit 17.

Here, attention is paid to the pixel data input to each MAC 20. Pieces of the pixel data g11, h11, i11, and j11 illustrated in FIG. 17 are all “1”. On the other hand, pieces of the pixel data h12, i12, and j12 illustrated in FIG. 18 are “1”, but the pixel data g12 is a zero value.

In this case, the multiplication processing in the three MACs 20 to which the pixel data g12 is input does not need to be executed since the processing result becomes a zero value regardless of the weight data w.

Therefore, the avoidance processing unit 21 loads the pixel data of another target area AR to the first local memory 26 without loading the pixel data g12 to the first local memory 26.

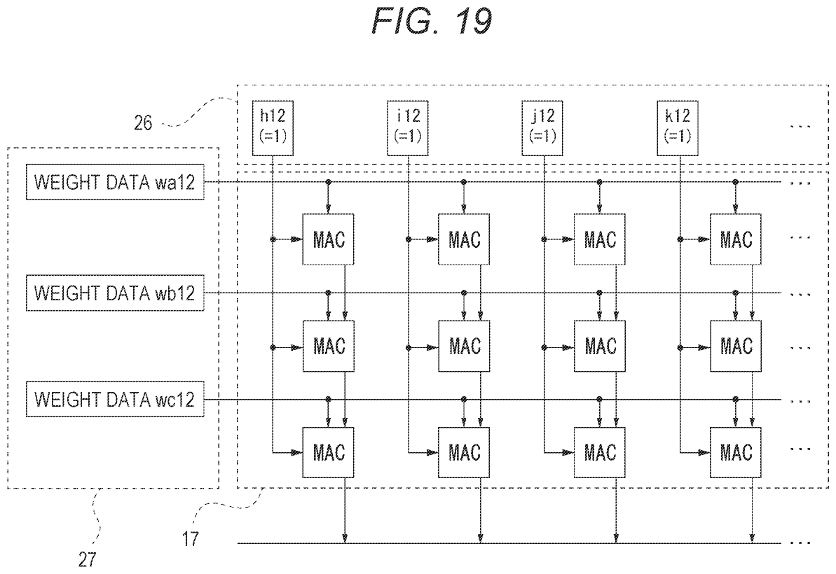

That is, a state as illustrated in FIG. 19 is obtained. Note that the pixel data k12 is pixel data of the target area AR other than the target areas AR7, AR8, AR9, and AR10.

In this manner, the data is loaded to the first local memory 26 while avoiding the pixel data set to the zero value.

The avoidance processing unit 21 notifies the multiply-accumulate operation control unit 25 of information for specifying pixel data that has not been loaded into the first local memory 26. The multiply-accumulate operation control unit 25 adds a zero value to the avoided multiply-accumulate operation result and stores the result in the third memory 24.

Thus, the multiply-accumulate operation control unit 25 can appropriately handle the operation result output from the MAC array unit 17.

Note that, in FIGS. 17, 18, and 19, an example is illustrated in which the avoidance processing unit 21 that performs processing of determining whether or not the pixel data is a zero value and selecting the pixel data to be loaded into the first local memory 26 is provided, but the avoidance processing unit 21 that performs processing of determining whether or not the weight data is a zero value and selecting the weight data to be loaded into the second local memory 27 may be provided. In this case, both the avoidance processing unit 21 related to the pixel data and the avoidance processing unit 21 related to the weight data may be provided, or only the avoidance processing unit 21 related to the weight data may be provided.

### 2-4. Configuration Example 4

In the signal processing unit 14D in configuration example 4, an avoidance processing unit 21D is provided for each MAC 20D.

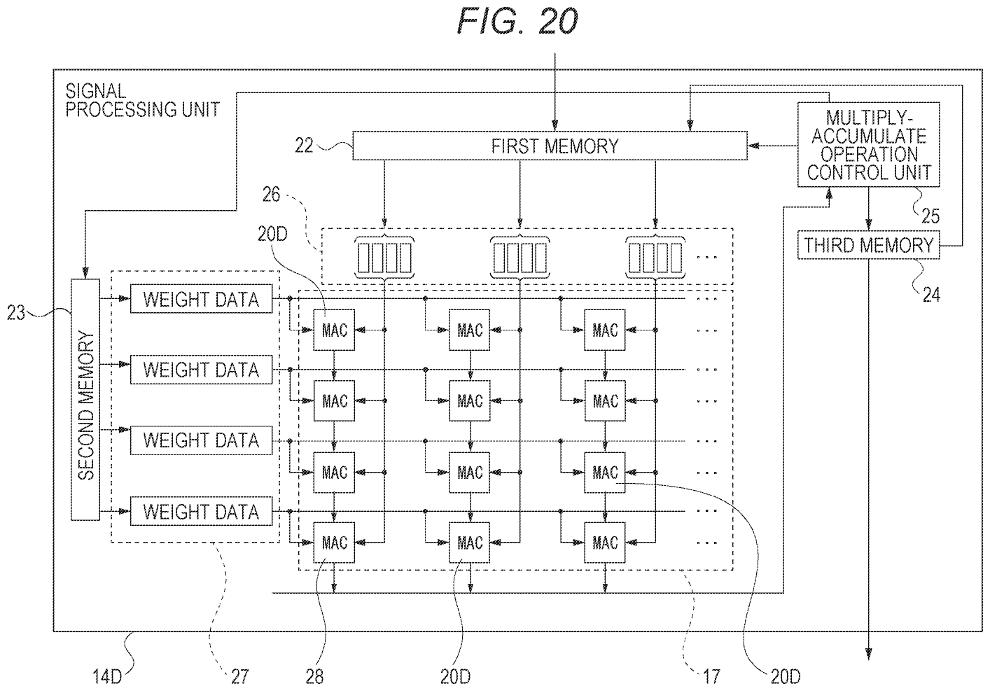

Specifically, as illustrated in FIG. 20, the pixel data is loaded from the first memory 22 to the first local memory 26 without passing through the avoidance processing unit 21. Furthermore, the weight data is loaded from the second memory 23 to the second local memory 27 without passing through the avoidance processing unit 21.

The pixel data and the weight data are input from the first local memory 26 and the second local memory 27 to the respective MACs 20D.

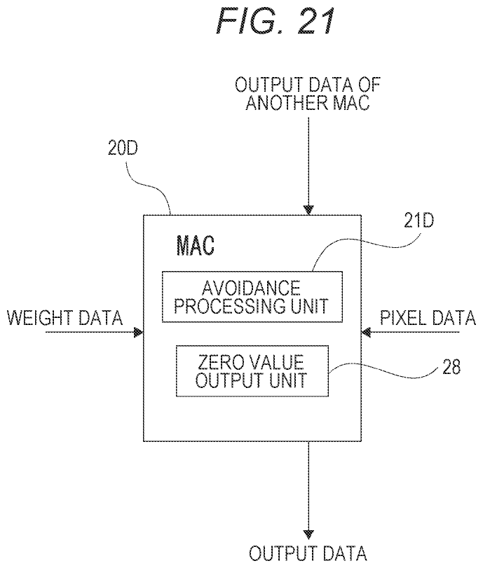

In addition to the addition circuit and the multiplication circuit, the MAC 20D includes the avoidance processing unit 21D and a zero value output unit 28 as illustrated in FIG. 21.

The avoidance processing unit 21D determines whether or not the input pixel data is a zero value. In a case where it is determined that the pixel data is a zero value, the clock applied to the MAC 20D is stopped, and the zero value output unit 28 operates to output the zero value as output data.

The avoidance processing unit 21D and the zero value output unit 28 can be configured by a logic circuit or the like. For example, the zero value output unit 28 can forcibly set the output value to a zero value by using a zero value and an AND circuit.

By stopping the clock in a case where the input pixel data is a zero value, it is possible to suppress the power consumption of the MAC 20D and contribute to power saving.

Note that, instead of determining whether or not the input pixel data is a zero value, it may be determined whether or not the input weight data is a zero value. Then, in a case where the weight data is a zero value, stopping of the clock and zero value output processing may be executed.

Of course, both the input pixel data and the input weight data may be monitored, and the clock stop and the zero value output processing may be performed in a case where at least one of the pixel data or the weight data is a zero value.

Note that, in the signal processing unit 14D in configuration example 4, a result of the avoided multiply-accumulate operation, a zero value is output to the MAC 20D or the multiply-accumulate operation control unit 25 in the next stage, and thus it is not necessary to notify the multiply-accumulate operation control unit 25 of information for specifying the avoided multiply-accumulate operation.

### 3. FLOWCHART

A processing flow for achieving each example described above is illustrated as a flowchart.

### 3-1. First Processing Example

In the first processing example, it is determined whether or not the pixel data is a zero value to appropriately avoid the multiply-accumulate operation. For example, configuration example 1 of the signal processing unit 14A can be implemented by executing the first processing example.

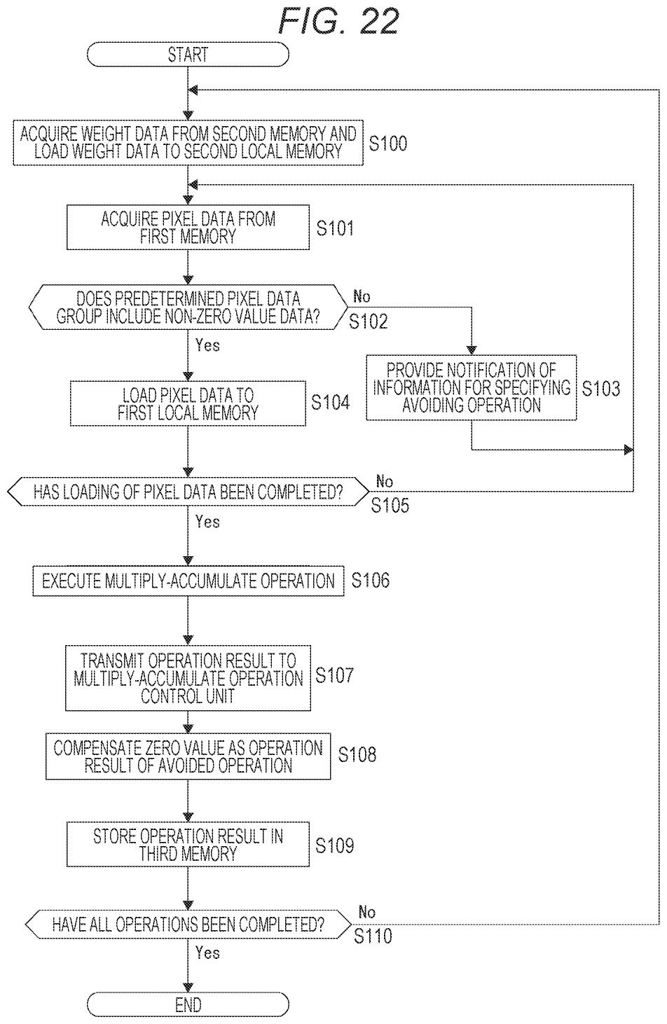

In step S100 in FIG. 22, the signal processing unit 14A acquires weight data from the second memory 23 and loads the weight data into the second local memory 27.

In step S101, the signal processing unit 14A acquires pixel data from the first memory 22. Subsequently, in step S102, the signal processing unit 14A determines whether or not the predetermined pixel data group includes data of non-zero value.

The predetermined pixel data group is, for example, pixel data a11, a12, a21, and a22 of the target area AR1 illustrated in FIG. 8, pixel data b11, b12, b21, and b22 of the target area AR2, and the like.

In a case where the data of non-zero value is not included in the predetermined pixel data group, that is, in a case where all pieces of the pixel data of the predetermined pixel data group are zero values, the signal processing unit 14A (avoidance processing unit 21) notifies the multiply-accumulate operation control unit 25 of information for specifying the operation avoided in step S103. Specifically, the multiply-accumulate operation control unit 25 is notified of position information (for example, x and y coordinates) in the longitudinal direction and the lateral direction for specifying the position of the control target area.

After notifying the multiply-accumulate operation control unit 25, the signal processing unit 14A (avoidance processing unit 21) returns to the processing of step S101 and acquires next pixel data.

On the other hand, in a case where it is determined in step S102 that the predetermined pixel data group includes the data of non-zero value, the signal processing unit 14A (avoidance processing unit 21) loads the acquired pixel data to the first local memory 26 in step S104.

In step S105, the signal processing unit 14A (avoidance processing unit 21) determines whether or not the loading of the pixel data has been completed. In a case where it is determined that the loading of the pixel data has not been completed, the signal processing unit 14A (avoidance processing unit 21) returns to the processing of step S101 and acquires next pixel data.

On the other hand, in a case where it is determined in step S105 that the loading of the pixel data has been completed, the signal processing unit 14A executes the multiply-accumulate operation in step S106. This processing is executed at a timing when data necessary for the multiply-accumulate operation is prepared in each of the first local memory 26 and the second local memory 27.

In step S107, the signal processing unit 14A transmits the operation result to the multiply-accumulate operation control unit 25.

In step S108, the signal processing unit 14A (multiply-accumulate operation control unit 25) compensates the zero value as the operation result of the avoided operation. Thus, it is possible to prevent the operation result of the avoided operation from being missing.

In step S109, the signal processing unit 14A (multiply-accumulate operation control unit 25) performs processing of storing the operation result in the third memory 24.

In step S110, the signal processing unit 14A (multiply-accumulate operation control unit 25) determines whether or not all the operations have been completed. In a case where the operations have not been completed, the series of processing starting from step S100 is executed again for new image data and the data as the operation result stored in the third memory 24 in step S109.

On the other hand, in a case where it is determined in step S110 that all the operations have been completed, the signal processing unit 14A (multiply-accumulate operation control unit 25) ends the series of processing illustrated in FIG. 22. At this time, processing of outputting the final operation result stored in the third memory 24 to the outside of the signal processing unit 14A may be executed.

### 3-2. Second Processing Example

In the second processing example, it is determined whether or not the pixel data is a zero value to appropriately avoid the multiply-accumulate operation, and it is determined whether or not the weight data is a zero value to appropriately avoid the multiply-accumulate operation. For example, configuration example 2 of the signal processing unit 14B can be implemented by executing the second processing example.

Note that processes similar to those in the first processing example are denoted by the same step numbers, and description thereof will be omitted as appropriate.

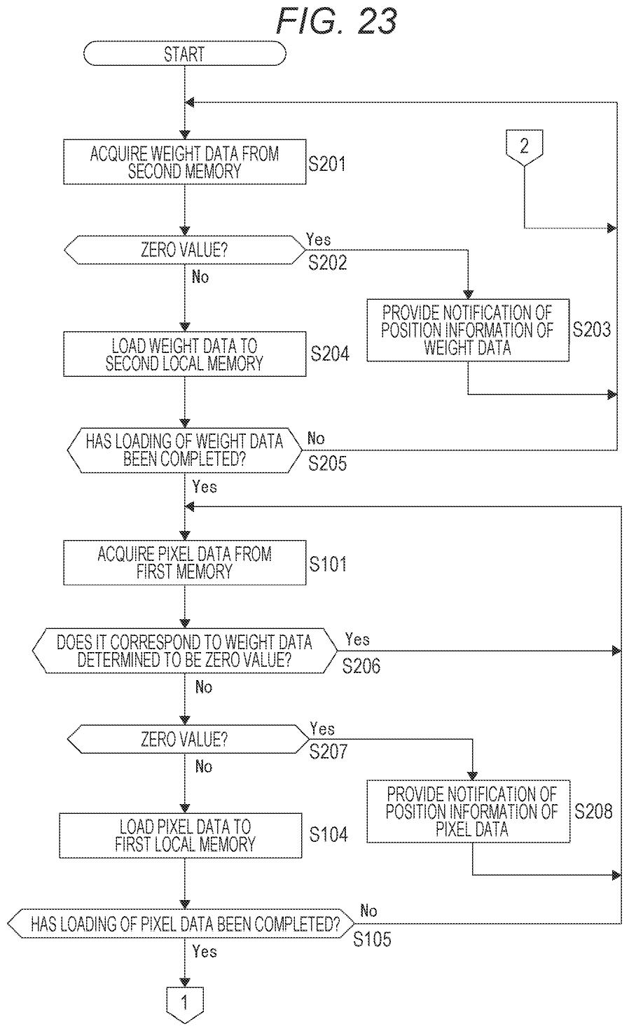

In step S201 of FIG. 23, the signal processing unit 14B (second avoidance processing unit 21b) acquires the weight data from the second memory 23.

In step S202, the signal processing unit 14B (second avoidance processing unit 21b) determines whether or not the acquired weight data is a zero value. In a case where it is determined to be a zero value, the signal processing unit 14B (second avoidance processing unit 21b) notifies the multiply-accumulate operation control unit 25 of the position information of the weight data in step S203.

After notifying the multiply-accumulate operation control unit 25, the signal processing unit 14B (second avoidance processing unit 21b) returns to the processing of step S201 and acquires next pixel data.

On the other hand, when it is determined that the acquired weight data is not a zero value, the signal processing unit 14B (second avoidance processing unit 21b) loads the acquired weight data to the second local memory 27 in step S204.

In step S205, the signal processing unit 14B (second avoidance processing unit 21b) determines whether or not the loading of the weight data has been completed. In a case where it is determined that the loading of the weight data has not been completed, the signal processing unit 14B (second avoidance processing unit 21b) returns to the processing of step S201 and acquires next weight data.

On the other hand, in a case where it is determined in step S205 that the loading of the weight data has been completed, the signal processing unit 14B (first avoidance processing unit 21a) acquires the pixel data from the first memory 22 in step S101.

In step S206, the signal processing unit 14B (first avoidance processing unit 21a) determines whether or not the acquired pixel data corresponds to weight data determined to be a zero value, that is, weight data that has not been loaded into the second local memory 27. The corresponding pixel data is, for example, the pixel data d21, the pixel data e21, the pixel data f21, and the like illustrated in FIG. 13.

In a case where it is determined that the acquired pixel data is data corresponding to the weight data determined to be a zero value, the signal processing unit 14B (first avoidance processing unit 21a) acquires new pixel data in step S101 without loading the acquired pixel data to the first local memory 26.

On the other hand, in a case where it is determined that the acquired pixel data is not the data corresponding to the weight data determined to be a zero value, the signal processing unit 14B (first avoidance processing unit 21a) determines whether or not the acquired pixel data is a zero value in step S207. In a case where it is determined that the acquired pixel data is a zero value, the signal processing unit 14B (first avoidance processing unit 21a) notifies the multiply-accumulate operation control unit 25 of the position information of the pixel data in step S208. That is, the acquired pixel data is not loaded to the first local memory 26.

In a case where the acquired pixel data does not correspond to the weight data set to a zero value and is not the zero value, the signal processing unit 14B (first avoidance processing unit 21a) loads the acquired pixel data to the first local memory 26 in step S104.

Subsequently, in step S105, the signal processing unit 14B (first avoidance processing unit 21a) determines whether or not the loading of the pixel data has been completed. In a case where it is determined that the loading of the pixel data has not been completed, the signal processing unit 14B (first avoidance processing unit 21a) returns to the processing of step S101 and acquires next pixel data.

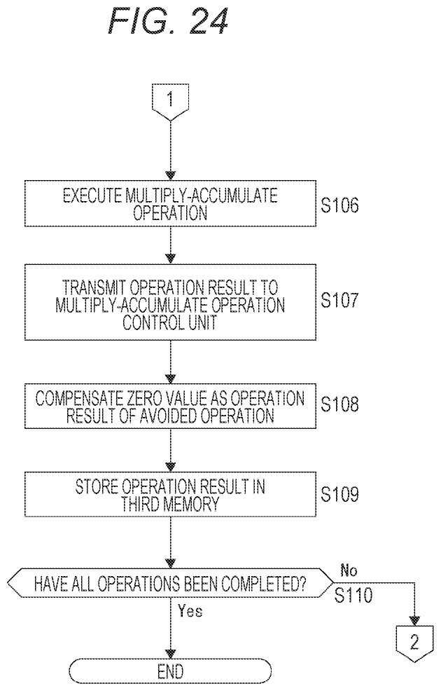

On the other hand, in a case where it is determined in step S105 that the loading of the pixel data has been completed, the signal processing unit 14B executes the multiply-accumulate operation in step S106 of FIG. 24, and transmits the operation result to the multiply-accumulate operation control unit 25 in step S107.

Subsequently, the signal processing unit 14B (multiply-accumulate operation control unit 25) compensates the zero value as the operation result of the avoided operation in step S108, and performs processing of storing the operation result in the third memory 24 in step S109.

In step S110, the signal processing unit 14B (multiply-accumulate operation control unit 25) determines whether or not all the operations have been completed. In a case where the operations have not been completed, the processing returns to the processing of step S201 in order to perform a new multiply-accumulate operation.

On the other hand, in a case where it is determined in step S110 that all the operations have been completed, the signal processing unit 14B (multiply-accumulate operation control unit 25) ends the series of processing illustrated in FIGS. 23 and 24. At this time, processing of outputting the final operation result stored in the third memory 24 to the outside of the signal processing unit 14B may be executed.

Note that, in a case where the number of target areas AR is large in the convolution processing, or the like, there is a case where the operation using the same filter F is not ended only by executing the multiply-accumulate operation processing of step S106 once. In this case, after the processing in step S110 is completed, the processing returns to step S101 in FIG. 23 without returning to step S201. Thus, the multiply-accumulate operation is appropriately executed.

### 3-3. Third Processing Example

The third processing example is an example of a flowchart for implementing configuration example 4 of the signal processing unit 14D. That is, the third processing example is for achieving a configuration in which the avoidance processing unit 21D and the zero value output unit 28 are provided for each MAC 20D.

Note that processes similar to those in the first processing example are denoted by the same step numbers, and description thereof will be omitted as appropriate.

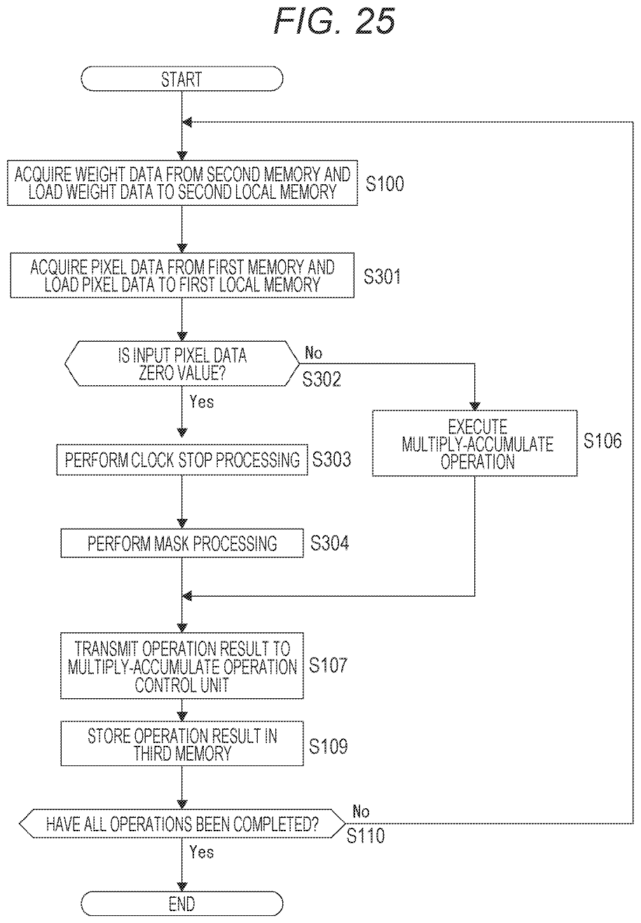

The signal processing unit 14D (multiply-accumulate operation control unit 25) acquires the weight data from the second memory 23 in step S100 in FIG. 25 and loads the weight data into the second local memory 27.

Next, in step S301, the signal processing unit 14D (multiply-accumulate operation control unit 25) acquires the pixel data from the first memory 22 and loads the pixel data into the first local memory 26.

In step S302, the signal processing unit 14D (avoidance processing unit 21D) determines whether or not the input pixel data is a zero value. This processing is performed for each MAC 20D.

In the MAC 20D in which it is determined that the input pixel data is a zero value, the signal processing unit 14D (avoidance processing unit 21D) performs clock stop processing in step S303. Moreover, in step S304, the signal processing unit 14D (avoidance processing unit 21D) causes the zero value output unit 28 to execute the zero value output processing. Thus, the multiply-accumulate operation is avoided and the power consumption is reduced in the MAC 20D.

Furthermore, a zero value is output from the MAC 20D as an operation result.

On the other hand, in the MAC 20D in which it is determined that the input pixel data is not a zero value, the signal processing unit 14D executes the multiply-accumulate operation processing in step S106.

Thus, the multiply-accumulate operation regarding the pixel data and the weight data as input data is executed.

After finishing the processing of step S304 or after finishing the processing of step S106, the signal processing unit 14D transmits the operation result to the multiply-accumulate operation control unit 25 in step S107.

In step S109, the signal processing unit 14D (multiply-accumulate operation control unit 25) performs processing of storing the operation result in the third memory 24.

In step S110, the signal processing unit 14D (multiply-accumulate operation control unit 25) determines whether or not all the operations have been completed. In a case where the operations have not been completed, the series of processing starting from step S100 in FIG. 25 is executed again for new image data and the data as the operation result stored in the third memory 24 in step S109.

On the other hand, in a case where it is determined in step S110 that all the operations have been completed, the signal processing unit 14D (multiply-accumulate operation control unit 25) ends the series of processing illustrated in FIG. 22.

### 4. MODIFICATIONS

Modifications of the above-described examples will be described.

### 4-1. First Modification

In each example, in a case where the input data of the pixel data and the weight data is a zero value, the processing for avoiding the multiply-accumulate operation related to the data has been described.

For example, when the image data includes many zero values as does an edge image, the number of operation times can be effectively reduced, and the power consumption by the MAC array unit 17 can be reduced.

However, the image data does not necessarily include many zero values. In such a case, if it is configured to avoid the multiply-accumulate operation in a case where the input data is a zero value, the multiply-accumulate operation that can be avoided is small, and thus the power consumption reduction effect is reduced.

Accordingly, it is conceivable to regard the input data as a zero value in a case where the input data is less than a predetermined threshold, to thereby increase the multiply-accumulate operation that can be avoided.

For example, in a case where the pixel data is represented by 4 bits, that is, in a case where the pixel data is any numerical value of 0 to 15, the multiply-accumulate operation related to the pixel data is avoided in a case where the predetermined threshold is “4” and the pixel data is 0 to 3. Of course, the predetermined threshold “4” is an example, and may be any number such as “8” or “10”.

This means that, for example, in an edge image, a weak edge pixel (a pixel having a small difference from an adjacent pixel) is ignored, and the convolution processing is performed on the basis of a strong edge pixel (a pixel having a large difference from an adjacent pixel). Thus, it is possible to improve the memory use efficiency and reduce the power consumption in performing the image recognition processing based on the stronger feature.

Note that, in a case where the present modification is achieved, in step S102 of FIG. 22, instead of determining whether or not a predetermined pixel data group includes a non-zero value, it is only required to determine whether or not the predetermined pixel data group includes pixel data equal to or more than a predetermined threshold.

Furthermore, as in configuration example 2 of the signal processing unit 14B, the multiply-accumulate operation may be avoided by regarding not only the pixel data but also the weight data as a zero value in a case where the weight data is less than a predetermined threshold. In this case, the predetermined threshold used for the determination of the pixel data and the predetermined threshold used for the determination of the weight data may be different. For example, the predetermined threshold used for determination of the pixel data may be set as a first threshold (for example, “4”)), and the predetermined threshold used for determination of the weight data may be set as a second threshold (for example, “2”).

In a case where the flowchart of FIG. 23 is applied, it is determined whether or not the weight data is less than the predetermined threshold instead of determining whether or not the weight data is a zero value in step S202.

Then, in step S206 of FIG. 23, it is determined whether or not to correspond to the weight data determined to be less than the predetermined threshold, and in step S207, it is determined whether or not the pixel data is less than the predetermined threshold.

### 4-2. Second Modification

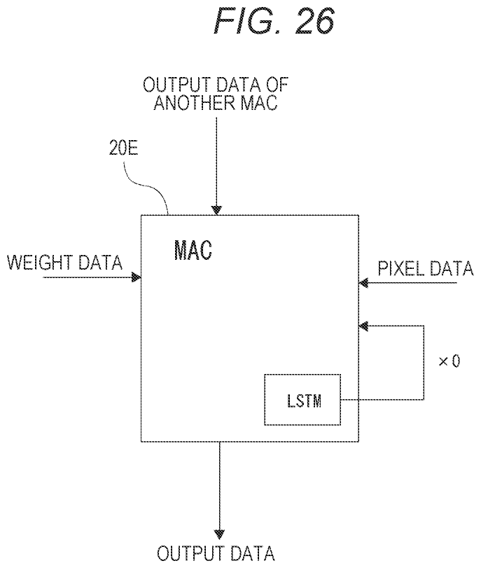

As a second modification, the MAC 20E may be capable of performing operations in a recurrent neural network (RNN). Specifically, the MAC 20E may include a long short-term memory (LSTM) (see FIG. 26).

In this case, as illustrated in FIG. 26, by setting the feedback output of the LSTM to OFF or setting the feedback output to zero times, the processing of each of the above-described embodiments can be achieved.

### 4-3. Modification of Sensor Unit

Several modifications are conceivable for the configuration of the sensor unit illustrated in FIG. 2. For example, in each of the examples described above, the sensor unit 3 functioning as a DVS has been described as an example, but the sensor unit 3 may be a sensor unit that generates image data by reading gradation signals from the pixels 16 instead of detecting the presence or absence of an event. In this case, it is a configuration in which the arbiter 12 is removed from FIG. 2.

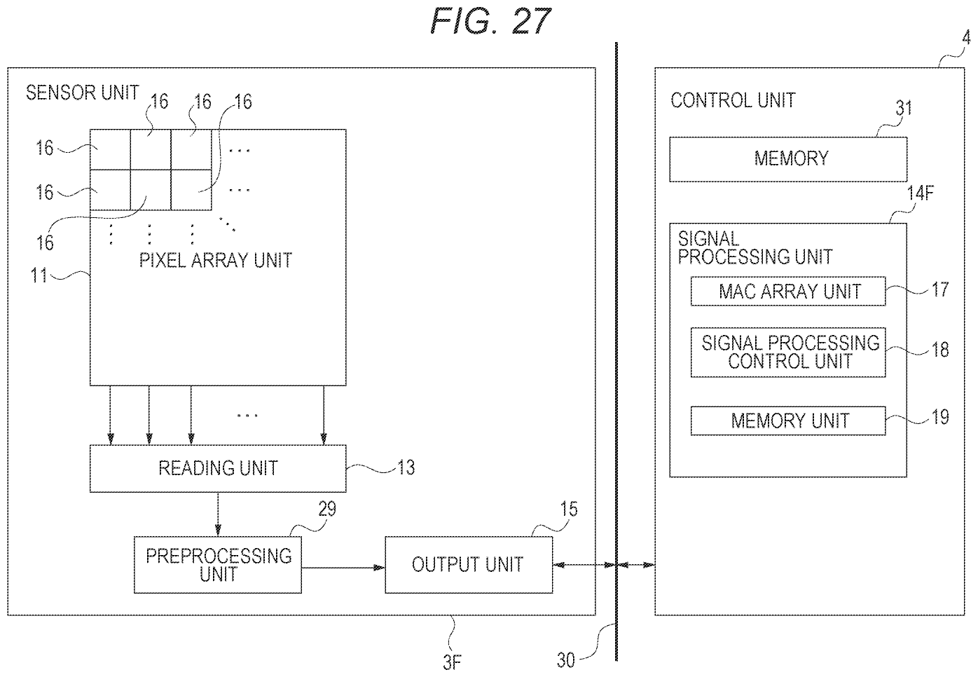

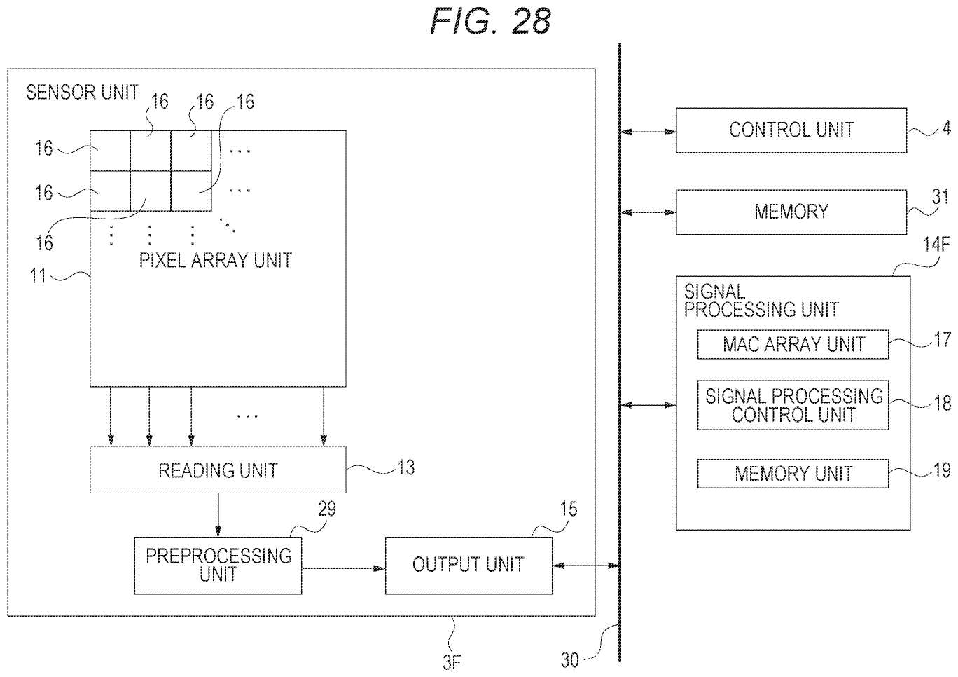

Furthermore, as illustrated in FIG. 27, a signal processing unit 14F including the avoidance processing unit 21 and the like may be provided outside the sensor unit 3.

Specifically, the sensor unit 3F includes the pixel array unit 11, the reading unit 13, a preprocessing unit 29, and the output unit 15, and the output unit 15 is connected to a bus 30. The preprocessing unit 29 is a unit that performs signal processing as preprocessing among various types of processing executed by the signal processing unit 14 in each of the above-described examples.

The control unit 4 including a memory 31 and the signal processing unit 14F is connected to the bus 30. That is, the signal processing unit 14F including the avoidance processing unit 21 and the like described above is provided outside the sensor unit 3F.

Furthermore, as illustrated in FIG. 28, the signal processing unit 14F including the avoidance processing unit 21 and the like may be provided outside the sensor unit 3F and outside the control unit 4.

Specifically, the sensor unit 3F includes the pixel array unit 11, the reading unit 13, the preprocessing unit 29, and the output unit 15, and the output unit 15 is connected to the bus 30.

The control unit 4, the memory 31, and the signal processing unit 14F are connected to the bus 30.

The signal processing unit 14F includes the MAC array unit 17, the signal processing control unit 18 including the avoidance processing unit 21 and the like, the memory unit 19, and the like.

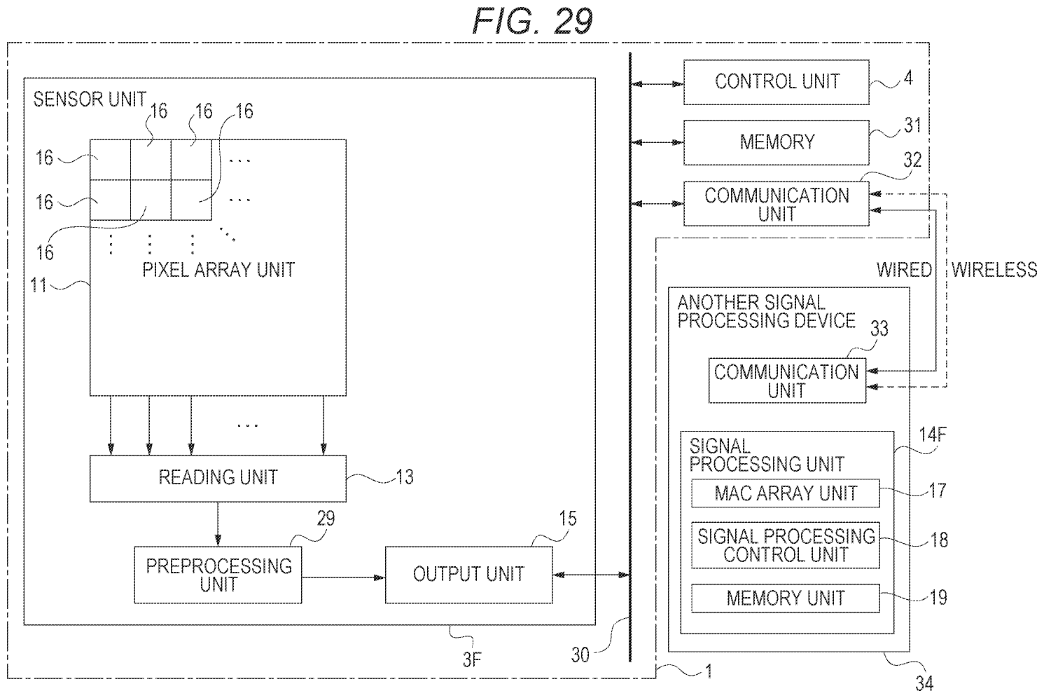

Moreover, as illustrated in FIG. 29, the signal processing unit 14F including the avoidance processing unit 21 and the like may be provided in another signal processing device.

Specifically, for example, the above-described various functions may be achieved by the imaging device 1 including the sensor unit 3F, the control unit 4, the memory 31, and the communication unit 32, and another signal processing device 34 including the signal processing unit 14F and the communication unit 32.

The communication unit 32 of the imaging device 1 can perform wired or wireless data communication with the communication unit 33 of another signal processing device 34.

By employing such various configurations, various functions as the signal processing unit described above can be achieved.

### 4-4. Other Modifications

In the above-described example, an example in which signal processing is performed on two-dimensional data such as image data has been described, but the application target of the processing may be one-dimensional data.

The one-dimensional data is, for example, sound data, output data such as speed data, acceleration data, and angular velocity data output from a gyro sensor, position information, and the like.

These pieces of one-dimensional data may be arranged in a different dimension direction for each predetermined amount of data to form two-dimensional data.

These pieces of data can be converted into data including many zero values by being converted into data relative to a reference value. By performing such conversion processing, the above-described power saving can be achieved at a higher level.

### 5. SUMMARY

As described above, the imaging device 1 as a signal processing device includes a multiply-accumulate operation unit (MAC 20, 20D, and 20E) arranged in a one-dimensional or two-dimensional array and capable of performing a multiply-accumulate operation in a neural network, a threshold determination processing unit (avoidance processing units 21 and 21D, a first avoidance processing unit 21a, and a second avoidance processing unit 21b) that determines whether or not input data (pixel data and weight data) used for operation by the multiply-accumulate operation unit is less than a predetermined threshold, and avoidance processing units 21 and 21D (the first avoidance processing unit 21a and the second avoidance processing unit 21b) that avoid multiply-accumulate operation processing for the input data in a case where the input data is less than the predetermined threshold.

The input data less than the predetermined threshold is, for example, input data that is a zero value, input data close to a zero value, or the like. In order to determine whether or not the value is a zero value, the threshold is set to “1”, and then it is determined whether or not the input data is less than the threshold.

In a case where the input data is a zero value, it is obvious that the multiply-accumulate operation result is a zero value, and calculation is possible without executing the multiply-accumulate operation processing. According to this configuration, since the multiply-accumulate operation is avoided in a case where the input data is a zero value, the multiply-accumulate operation unit is prevented from being used to execute useless operation, and power consumption can be reduced.

As described in the signal processing unit 14A and the like of configuration example 1, the input data may include first type input data (pixel data) and second type input data (weight data), the threshold determination processing unit (the avoidance processing units 21 and 21D, the first avoidance processing unit 21a, and the second avoidance processing unit 21b) may perform the determination for the first type input data, and the avoidance processing units 21 and 21D (the first avoidance processing unit 21a and the second avoidance processing unit 21b) may avoid the multiply-accumulate operation processing for the first type input data in a case where the first type input data is less than the predetermined threshold.

Note that, in the description of configuration example 1, whether or not the first type input data is a zero value is determined by setting the predetermined threshold to “1”.

The multiply-accumulate operation unit (MAC 20, 20D, and 20E) multiplies the first type input data by the second type input data. That is, in a case where any one of the first type input data and the second type input data is a zero value, the multiplication result also is a zero value. With this configuration, the multiply-accumulate operation processing is avoided in a case where the first type input data is a zero value.

According to this configuration, since the multiply-accumulate operation processing is avoided in a case where the first type input data is a zero value, it is possible to efficiently avoid the multiply-accumulate operation in which the operation result is a zero value.

As described in each example of the signal processing unit 14A in configuration example 1, the second type input data may be weight data that is information of a weight to multiply the first type input data (pixel data).

The weight data is, for example, a coefficient of a filter applied to image data in a predetermined range in the CNN, and the like. It is difficult to consider a filter in which all the filter coefficients are zero values.

Therefore, for example, by performing determination processing as to whether or not the first type input data set as the image data of the predetermined area is a zero value and appropriately avoiding the multiply-accumulate operation processing, it is possible to efficiently eliminate unnecessary multiply-accumulate operation and to achieve power saving.

As described in configuration example 1, the threshold determination processing unit (avoidance processing unit 21, 21D, first avoidance processing unit 21a, second avoidance processing unit 21b) may be provided one each for a plurality of the multiply-accumulate operation units (MAC 20, 20D, and 20E).

It is determined whether each of a plurality of pieces of input data input to the plurality of multiply-accumulate operation units is less than a predetermined threshold, for example, whether the input data is a zero value.

Thus, it is possible to perform processing such as replacing input data determined to be less than the predetermined threshold, and it is possible to efficiently use the multiply-accumulate operation unit. That is, it is possible to reduce the number of times of extension and use of the multiply-accumulate operation unit until a predetermined result is obtained, and it is possible to contribute to reduction of consumption reduction.

As described in configuration example 1, configuration example 2, configuration example 3, and the like, the avoidance processing units 21 and 21D (the first avoidance processing unit 21a and the second avoidance processing unit 21b) may change the input data input to the multiply-accumulate operation unit (MAC 20, 20D, and 20E) in a case where the input data (the pixel data and the weight data) is less than the predetermined threshold, in such a manner as to avoid the multiply-accumulate operation processing for the input data that is less than the predetermined threshold.

Thus, input data equal to or more than the predetermined threshold is input to the multiply-accumulate operation unit.

Therefore, the multiply-accumulate operation unit is effectively used, and unnecessary multiply-accumulate operation can be prevented from being executed.

As described in configuration example 1, configuration example 2, configuration example 3, and the like, the multiply-accumulate operation control unit 25 that manages input data (pixel data and weight data) and output data of the multiply-accumulate operation processing may be provided, and the avoidance processing units 21 and 21D (the first avoidance processing unit 21a and the second avoidance processing unit 21b) may notify the multiply-accumulate operation control unit 25 of information for specifying the input data for which the multiply-accumulate operation processing has been avoided.

Thus, the multiply-accumulate operation control unit 25 can grasp the correspondence between the input data used for the multiply-accumulate operation and the multiply-accumulate operation result.

Therefore, the operation result can be appropriately handled, and for example, the convolution processing in the CNN can be correctly executed. Furthermore, since unnecessary multiply-accumulate operation processing in which the operation result becomes a zero value is avoided, power saving can be achieved.

As described in configuration example 4, the avoidance processing units 21 and 21D (the first avoidance processing unit 21a and the second avoidance processing unit 21b) may be provided for each multiply-accumulate operation unit (MAC 20, 20D, and 20E).

By providing the avoidance processing unit 21 for each multiply-accumulate operation unit, the processing load of the determination processing executed by one avoidance processing unit 21 is made small. In this determination processing, it is determined whether or not the input data (the pixel data and the weight data) is less than a predetermined threshold, for example, whether or not the input data is a zero value.

Thus, for example, it is possible to avoid the multiply-accumulate operation processing without performing processing such as replacing the input data with a non-zero value. Therefore, power saving can be achieved by simple processing.

As described in configuration example 4, the avoidance processing unit 21D may avoid the multiply-accumulate operation processing for the input data (the pixel data and the weight data) less than the predetermined threshold, and output a zero value as a processing result of the multiply-accumulate operation processing.

For example, in a case where the input data is a zero value, it is obvious that an operation result is a zero value, and thus the output data is forcibly set to a zero value after avoiding the multiply-accumulate operation processing.

Thus, it is possible to obtain correct output data as a multiply-accumulate operation result, and it is possible to obtain an effect of reducing power consumption by avoiding operation processing.

The input data includes first type input data (pixel data) and second type input data (weight data), and in a case where the first type input data is less than a first threshold, the avoidance processing units 21 and 21D (the first avoidance processing unit 21a and the second avoidance processing unit 21b) may change the first type input data input to the multiply-accumulate operation unit (MAC 20, 20D, and 20E) and notify the multiply-accumulate operation control unit 25 of information for specifying the changed first type input data.

Thus, comparison processing with a predetermined threshold for only one of the first type input data and the second type input data that are input data can be executed.

Therefore, the processing load can be reduced and the power consumption can be reduced as compared with a case where the determination processing is executed for both the first type input data and the second type input data.

As in a case where the first modification is applied to configuration example 2, in a case where the second type input data (weight data) is less than a second threshold, the avoidance processing unit (the first avoidance processing unit 21a and the second avoidance processing unit 21b) may change the second type input data input to the multiply-accumulate operation unit (MAC 20) and change the first type input data (pixel data) corresponding to the changed second type input data, and notify the multiply-accumulate operation control unit 25 of information for specifying the changed first type input data and the changed second type input data.

The corresponding data is a number to be multiplied by a number to multiply in the multiply-accumulate operation. In multiplication processing, in a case where a certain number to multiply is a zero value, the result is a zero value regardless of the value of the number to be multiplied. In order to omit such multiplication processing, processing of omitting the number to multiply that is a zero value (second type input data) and omitting the corresponding number to be multiplied is performed.

Thus, in a case where the second type input data is a zero value, the multiplication processing and subsequent addition processing are avoided, and the multiplication processing and the addition processing in which an operation result is a non-zero value can be executed in advance. Furthermore, since the multiply-accumulate operation control unit can grasp the avoided multiplication processing and addition processing, the operation result of the multiply-accumulate operation processing can be appropriately handled. Moreover, since the number of times of multiplication processing and addition processing executed to obtain a specific result can be reduced, it is possible to contribute to power saving.

As described in configuration example 2, the multiply-accumulate operation control unit 25 may manage a multiply-accumulate operation result of the first type input data (pixel data) and the second type input data (weight data), and compensate a zero value for an avoided multiply-accumulate operation result.

The avoided multiply-accumulate operation processing, that is, the skipped multiply-accumulate operation processing can be specified by receiving information for specifying the corresponding first type input data and second type input data.

Then, as the processing result of the specified multiply-accumulate operation processing, the processing result of the multiply-accumulate operation processing can be obtained so as not to lack data by supplementing and managing zero values. Therefore, the convolution operation in the CNN or the like can be efficiently performed with power saving.

As described with reference to FIGS. 1, 2, 3, and the like, the imaging device 1 includes the pixel array unit 11 in which photoelectric conversion elements (pixels 16) are arranged in a one-dimensional or two-dimensional array, and the signal processing unit 14 (14A, 14B, 14C, 14D, and 14F) to which input data (pixel data and weight data) based on an output signal of the pixel array unit 11 is input, in which the signal processing unit 14 includes a multiply-accumulate operation unit (MAC 20, 20D, and 20E) arranged in a one-dimensional or two-dimensional array and capable of performing a multiply-accumulate operation in a neural network, a threshold determination processing unit (avoidance processing units 21 and 21D, the first avoidance processing unit 21a, and the second avoidance processing unit 21b) that determines whether or not the input data used for operation by the multiply-accumulate operation unit is less than a predetermined threshold, and avoidance processing units 21 and 21D (the first avoidance processing unit 21a and the second avoidance processing unit 21b) that avoid the multiply-accumulate operation processing for the input data in a case where the input data is less than the predetermined threshold.

The signal processing unit 14 included in the imaging device 1 is required to be power saving due to problems such as a battery.

According to the present configuration, in the imaging device capable of performing at least a part of the convolution operation in the CNN or the like, this configuration is preferable because the power consumed in the multiply-accumulate operation processing can be reduced.

As described with reference to FIGS. 1, 2, 3, and the like, the pixel array unit 11 and the signal processing unit 14 may be integrally formed.

Since the pixel array unit 11 and the signal processing unit 14 are integrally formed, the imaging device 1 can be downsized.

Therefore, the ease of handling of the imaging device 1 can be improved.

As described with reference to FIG. 2 and the like, feature data extracted on the basis of an output signal of the pixel array unit 11 may be input to the signal processing unit 14 (14A, 14B, 14C, 14D, and 14F) as the input data.

The feature data often includes data having a zero value or less than a predetermined threshold.

Therefore, in many cases, the multiply-accumulate operation processing can be performed with high efficiency, and the power consumption reduction effect can be further enhanced.

Note that effects described in the present description are merely examples and are not limited, and other effects may be provided.

### 6. PRESENT TECHNOLOGY

(1)
A signal processing device, including:
a multiply-accumulate operation unit arranged in a one-dimensional or two-dimensional array and capable of performing a multiply-accumulate operation in a neural network;
a threshold determination processing unit that determines whether or not input data used for operation by the multiply-accumulate operation unit is less than a predetermined threshold; and
an avoidance processing unit that avoids multiply-accumulate operation processing for the input data in a case where the input data is less than the predetermined threshold.
(2)
The signal processing device according to (1) above, in which
the input data includes first type input data and second type input data,
the threshold determination processing unit performs the determination for the first type input data, and
the avoidance processing unit avoids the multiply-accumulate operation processing for the first type input data in a case where the first type input data is less than the predetermined threshold.
(3)
The signal processing device according to (2) above, in which
the second type input data is weight data that is information of a weight to multiply the first type input data.
(4)
The signal processing device according to any one of (1) to (3) above, in which
the threshold determination processing unit is provided one each for a plurality of the multiply-accumulate operation units.
(5)
The signal processing device according to (4) above, in which
the avoidance processing unit changes the input data input to the multiply-accumulate operation unit in a case where the input data is less than the predetermined threshold in such a manner as to avoid the multiply-accumulate operation processing for the input data that is less than the predetermined threshold.
(6)
The signal processing device according to (5) above, further including
a multiply-accumulate operation control unit that manages input data and output data of the multiply-accumulate operation processing, in which
the avoidance processing unit notifies the multiply-accumulate operation control unit of information for specifying the input data for which the multiply-accumulate operation processing has been avoided.
(7)
The signal processing device according to any one of (1) to (6) above, in which
the avoidance processing unit is provided for each of the multiply-accumulate operation units.
(8)
The signal processing device according to (7) above, in which
the avoidance processing unit avoids the multiply-accumulate operation processing for the input data that is less than the predetermined threshold, and outputs a zero value as a processing result of the multiply-accumulate operation processing.
(9)
The signal processing device according to (6) above, in which
the input data includes first type input data and second type input data, and
in a case where the first type input data is less than a first threshold, the avoidance processing unit
changes the first type input data input to the multiply-accumulate operation unit and notifies the multiply-accumulate operation control unit of information for specifying the changed first type input data.
(10)
The signal processing device according to (9) above, in which
in a case where the second type input data is less than a second threshold, the avoidance processing unit changes the second type input data input to the multiply-accumulate operation unit and changes the first type input data corresponding to the changed second type input data, and notifies the multiply-accumulate operation control unit of information for specifying the changed first type input data and the changed second type input data.
(11)
The signal processing device according to (10) above, in which
the multiply-accumulate operation control unit manages a multiply-accumulate operation result of the first type input data and the second type input data, and compensates a zero value for an avoided multiply-accumulate operation result.
(12)
An imaging device, including:
a pixel array unit in which photoelectric conversion elements are arranged in a one-dimensional or two-dimensional array;
a signal processing unit to which input data based on an output signal of the pixel array unit is input, in which
the signal processing unit includes
a multiply-accumulate operation unit arranged in a one-dimensional or two-dimensional array and capable of performing a multiply-accumulate operation in a neural network;
a threshold determination processing unit that determines whether or not the input data used for operation by the multiply-accumulate operation unit is less than a predetermined threshold; and
an avoidance processing unit that avoids multiply-accumulate operation processing for the input data in a case where the input data is less than the predetermined threshold.
(13)
The imaging device according to (12) above, in which
the pixel array unit and the signal processing unit are integrally formed.
(14)
The imaging device according to (13) above, in which
feature data extracted on the basis of an output signal of the pixel array unit is input to the signal processing unit as the input data.
(15)
A signal processing method to be executed by a signal processing device, the method including:
determining whether or not input data used for multiply-accumulate operation in a neural network is less than a predetermined threshold; and
avoiding multiply-accumulate operation processing for the input data in a case where the input data is less than the predetermined threshold.

### REFERENCE SIGNS LIST

1 Imaging device (signal processing device)
20, 20D, 20E MAC (multiply-accumulate operation unit)
20-1, 20-2, 20-3, 20-4 MAC (multiply-accumulate operation unit)
20-5, 20-6, 20-7, 20-8 MAC (multiply-accumulate operation unit)
20-9, 20-10, 20-11, 20-12 MAC (multiply-accumulate operation unit)
21, 21D Avoidance processing unit (threshold determination processing unit)
21a First avoidance processing unit (threshold determination processing unit)
21b Second avoidance processing unit (threshold determination processing unit)
25 Multiply-accumulate operation control unit

1. A signal processing device, comprising:
a multiply-accumulate operation unit arranged in a one-dimensional or two-dimensional array and capable of performing a multiply-accumulate operation in a neural network;
a threshold determination processing unit that determines whether or not input data used for operation by the multiply-accumulate operation unit is less than a predetermined threshold; and
an avoidance processing unit that avoids multiply-accumulate operation processing for the input data in a case where the input data is less than the predetermined threshold.

2. The signal processing device according to claim 1, wherein
the input data includes first type input data and second type input data,
the threshold determination processing unit performs the determination for the first type input data, and
the avoidance processing unit avoids the multiply-accumulate operation processing for the first type input data in a case where the first type input data is less than the predetermined threshold.

3. The signal processing device according to claim 2, wherein
the second type input data is weight data that is information of a weight to multiply the first type input data.

4. The signal processing device according to claim 1, wherein
the threshold determination processing unit is provided one each for a plurality of the multiply-accumulate operation units.

5. The signal processing device according to claim 4, wherein
the avoidance processing unit changes the input data input to the multiply-accumulate operation unit in a case where the input data is less than the predetermined threshold in such a manner as to avoid the multiply-accumulate operation processing for the input data that is less than the predetermined threshold.

6. The signal processing device according to claim 5, further comprising
a multiply-accumulate operation control unit that manages input data and output data of the multiply-accumulate operation processing, wherein
the avoidance processing unit notifies the multiply-accumulate operation control unit of information for specifying the input data for which the multiply-accumulate operation processing has been avoided.

7. The signal processing device according to claim 1, wherein
the avoidance processing unit is provided for each of the multiply-accumulate operation units.

8. The signal processing device according to claim 7, wherein
the avoidance processing unit avoids the multiply-accumulate operation processing for the input data that is less than the predetermined threshold, and outputs a zero value as a processing result of the multiply-accumulate operation processing.

9. The signal processing device according to claim 6, wherein
the input data includes first type input data and second type input data, and
in a case where the first type input data is less than a first threshold, the avoidance processing unit
changes the first type input data input to the multiply-accumulate operation unit and notifies the multiply-accumulate operation control unit of information for specifying the changed first type input data.

10. The signal processing device according to claim 9, wherein
in a case where the second type input data is less than a second threshold, the avoidance processing unit changes the second type input data input to the multiply-accumulate operation unit and changes the first type input data corresponding to the changed second type input data, and notifies the multiply-accumulate operation control unit of information for specifying the changed first type input data and the changed second type input data.

11. The signal processing device according to claim 10, wherein
the multiply-accumulate operation control unit manages a multiply-accumulate operation result of the first type input data and the second type input data, and compensates a zero value for an avoided multiply-accumulate operation result.

12. An imaging device, comprising:
a pixel array unit in which photoelectric conversion elements are arranged in a one-dimensional or two-dimensional array;
a signal processing unit to which input data based on an output signal of the pixel array unit is input, wherein
the signal processing unit includes
a multiply-accumulate operation unit arranged in a one-dimensional or two-dimensional array and capable of performing a multiply-accumulate operation in a neural network;
a threshold determination processing unit that determines whether or not the input data used for operation by the multiply-accumulate operation unit is less than a predetermined threshold; and
an avoidance processing unit that avoids multiply-accumulate operation processing for the input data in a case where the input data is less than the predetermined threshold.

13. The imaging device according to claim 12, wherein
the pixel array unit and the signal processing unit are integrally formed.

14. The imaging device according to claim 13, wherein
feature data extracted on a basis of an output signal of the pixel array unit is input to the signal processing unit as the input data.

15. A signal processing method to be executed by a signal processing device, the method comprising:
determining whether or not input data used for multiply-accumulate operation in a neural network is less than a predetermined threshold; and
avoiding multiply-accumulate operation processing for the input data in a case where the input data is less than the predetermined threshold.
